(19) United States
(12) Patent Application Publication
(10) Pub. No.: US 2024/0305754 A1
(43) Pub. Date: Sep. 12, 2024

(54) PROJECTION DEVICE AND OBSTACLE AVOIDANCE PROJECTION METHOD

(71) Applicant: HISENSE VISUAL TECHNOLOGY CO., LTD., Qingdao (CN)

(72) Inventors: Pingguang LU, Qingdao (CN); Hao WANG, Qingdao (CN); Yingjun WANG, Qingdao (CN); Guohua YUE, Qingdao (CN); Gaoming TANG, Qingdao (CN); Yinghao HE, Qingdao (CN); Qingqing ZHENG, Qingdao (CN); Lingyun ZHEN, Qingdao (CN); Chao SUN, Qingdao (CN); Caifeng LI, Qingdao (CN); Shanhao LU, Qingdao (CN)

(21) Appl. No.: 18/666,806

(22) Filed: May 16, 2024

Related U.S. Application Data
(63) Continuation of application No. PCT/CN2022/132249, filed on Nov. 16, 2022.

(30) Foreign Application Priority Data
Nov. 16, 2021 (CN) 202111355866.0
May 26, 2022 (CN) 202210590075.4
May 30, 2022 (CN) 202210600617.1

(51) Int. Cl. H04N 9/31

(52) U.S. Cl. CPC H04N 9/3161; H04N 9/317; H04N 9/3185; H04N 9/3194

(57) ABSTRACT

Disclosed in the present application are a projection device and a method for the projection device. A projection device comprises a light modulation assembly, a lens, a distance sensor, an image collection device and a controller. The method comprises: in response to a start-up instruction for a projection device, starting the projection device; detecting whether there is a blocking object between the projection device and a projection surface according to the positional relationship between a lens, a distance sensor and an image collection device on a first plane and a distance measurement value of the distance sensor, wherein the first plane is a plane on the projection device that is parallel to the projection surface during projection, and the projection surface is used for receiving and displaying projection content, which is projected by a light modulation assembly.

### CROSS-REFERENCE TO RELATED APPLICATIONS

This application is a continuation application of PCT/CN2022/132249, filed on Nov. 16, 2022, which claims the priority to the Chinese patent applications No. 202111355866.0 filed on Nov. 16, 2021, No. 202210590075.4 filed on May 26, 2022, and No. 202210600617.1 filed on May 30, 2022, the entire contents of all of which are incorporated herein by reference.

### TECHNICAL FIELD

The disclosure relates to the technical field of projection, in particular to a projection device and a projection method.

### BACKGROUND

A projection device is based on an imaging technology to project media data onto projection media such as a wall, a curtain, and a screen, so that the projection media present the media data. A user may fixedly place a projector at a designated position or move the projection device to meet the requirements of a projection position and direction.

In a use process of the projection device, there may be a blocking object in front of a first plane. If the blocking object obstructs a lens of the projection device, it will affect a projection display of the media data on one hand, and on the other hand, a high temperature of light projected by the lens can easily cause high-temperature burns to the blocking object, and fire hazards may even be caused especially when an ignition point of the blocking object is low. In addition, if the blocking object obstructs relevant elements on the projection device, such as a camera or a distance sensor, focusing and correction of the projection device itself may also be affected, leading to abnormal projection.

### SUMMARY

A projection device according to an embodiment of the disclosure includes: a lens; a light modulation assembly, configured to project projection content onto a projection surface; a distance sensor, configured to detect a distance detection value between the projection surface and the light modulation assembly; an image collection device, configured to photograph an image of the projection content; and a controller, configured to: in response to a power-on command for the projection device, start the projection device; detect whether a blocking object exists between the projection device and the projection surface according to a positional relationship of the lens, the distance sensor and the image collection device on a first plane and the distance detection value of the distance sensor, wherein the first plane is a plane on the projection device that is parallel to the projection surface during projection; and in response to that it is detected that the blocking object exists between the projection device and the projection surface, control sending of prompt information for prompting to remove the blocking object.

An embodiment of the disclosure provides an obstacle avoidance projection method for a projection device. The projection device includes a light modulation assembly, a lens, a distance sensor, an image collection device, and a controller, and the method includes: in response to a power-on command for the projection device, starting the projection device; detecting whether a blocking object exists between the projection device and a projection surface according to a positional relationship of the lens, the distance sensor and the image collection device on a first plane and a distance detection value of the distance sensor, wherein the first plane is a plane on the projection device that is parallel to the projection surface during projection, and the projection surface is used for receiving and displaying projection content projected by the light modulation assembly; and in response to that it is detected that the blocking object exists between the projection device and the projection surface, controlling sending of prompt information for prompting to remove the blocking object.

### BRIEF DESCRIPTION OF FIGURES

FIG. 1 is a schematic diagram of a projection scenario of a projection device according to some embodiments of the disclosure.

FIG. 2 is a schematic diagram of a light path of a projection device according to some embodiments of the disclosure.

FIG. 3 is a schematic diagram of a circuit architecture of a projection device according to some embodiments of the disclosure.

FIG. 4 is a schematic diagram of a light path of a projection device according to some embodiments of the disclosure.

FIG. 5 is a schematic structural diagram of a circuit of a projection device according to some embodiments of the disclosure.

FIG. 6 is a schematic structural diagram of a lens of a projection device according to some embodiments of the disclosure.

FIG. 7 is a schematic structural diagram of a distance sensor and a camera of a projection device according to some embodiments of the disclosure.

FIG. 8 is a schematic diagram of a system framework of a projection device for implementing display control according to some embodiments of the disclosure.

FIG. 9 is a schematic structural diagram of a first plane of a projection device according to some embodiments of the disclosure.

FIG. 10 is a schematic diagram of a first blocking scenario according to some embodiments of the disclosure.

FIG. 11 is a schematic diagram of a second blocking scenario according to some embodiments of the disclosure.

FIG. 12 is a schematic diagram of a third blocking scenario according to some embodiments of the disclosure.

FIG. 13 is a schematic diagram of a fourth blocking scenario according to some embodiments of the disclosure.

FIG. 14 is a schematic structural diagram of a first plane of another projection device according to some embodiments of the disclosure.

FIG. 15 is a schematic diagram of a fifth blocking scenario according to some embodiments of the disclosure.

FIG. 16 is a schematic diagram of a sixth blocking scenario according to some embodiments of the disclosure.

FIG. 17 is a schematic diagram of a seventh blocking scenario according to some embodiments of the disclosure.

FIG. 18 is a schematic diagram of an eighth blocking scenario according to some embodiments of the disclosure.

FIG. 19 is a flow diagram of a first projection detection method according to some embodiments of the disclosure.

FIG. 20 is a flow diagram of a second projection detection method according to some embodiments of the disclosure.

FIG. 21 is a flow diagram of a third projection detection method according to some embodiments of the disclosure.

FIG. 22 is a schematic diagram of a signaling interaction for realizing prevention of eye-irradiation function in a projection device according to some embodiments of the disclosure.

FIG. 23 is a schematic diagram of a signaling interaction for realizing a display image correction function in a projection device according to some embodiments of the disclosure.

FIG. 24 is a schematic flow diagram of implementing an automatic focusing algorithm in a projection device according to some embodiments of the disclosure.

FIG. 25 is a schematic flow diagram of implementing keystone correction and an obstacle avoidance algorithm in a projection device according to some embodiments of the disclosure.

FIG. 26 is a schematic flow diagram of implementing a screen entry algorithm in a projection device according to some embodiments of the disclosure.

FIG. 27 is a schematic flow diagram of implementing an eye-irradiation preventing algorithm in a projection device according to some embodiments of the disclosure.

FIG. 28 is a schematic flow diagram of obstacle avoidance projection in a projection device according to some embodiments of the disclosure.

FIG. 29 is a schematic diagram of an obstacle set and a contour level according to some embodiments of the disclosure.

FIG. 30 is a schematic flow diagram of updating an obstacle contour coordinate set according to some embodiments of the disclosure.

FIG. 31 is a schematic diagram of a projection region change according to some embodiments of the disclosure.

FIG. 32 is a schematic flow diagram of updating an obstacle contour coordinate set according to some embodiments of the disclosure.

FIG. 33 is a schematic diagram of a rectangular grid and a non-obstacle region according to some embodiments of the disclosure.

FIG. 34 is a schematic flow diagram of recombining a hue, saturation and value (HSV) image according to some embodiments of the disclosure.

### DETAILED DESCRIPTION

A projection device is a device that may project media data onto a projection medium. The projection device may be connected with a computer, a broadcasting television network, the Internet, a video compact disc (VCD), a digital versatile disc recordable (DVD), a game console, a digital video (DV) and other devices through different interfaces to receive the media data to for projection. The media data includes, but is not limited to types such as an image, a video, and a text, etc., and the projection medium includes, but is not limited to physical forms such as a wall, a curtain and a screen, etc.

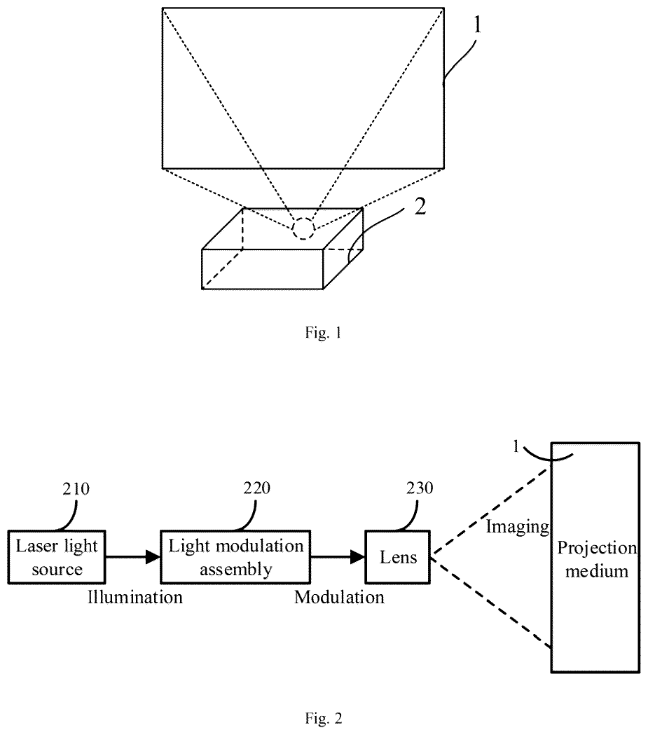

FIG. 1 shows a schematic diagram of a projection scenario of a projection device according to some embodiments of the disclosure, and FIG. 2 shows a schematic diagram of a light path of the projection device.

In some embodiments, referring to FIG. 1 and FIG. 2, the projection device according to the disclosure includes a projection medium 1 and an apparatus 2 for projection. The projection medium 1 can be fixed on a first position, and the apparatus 2 for projection can be placed on a second position. By adjusting a relationship between the first position and the second position, a projection image of the apparatus 2 for projection matches a projection surface of the projection medium 1. The apparatus 2 for projection includes a projection assembly, and the projection assembly includes a laser light source 210, a light modulation assembly 220, and a lens 230. The laser light source 210 can provide light for the light modulation assembly 220, the light modulation assembly 220 can modulate a light beam of the light source and outputs it to the lens 230, the lens 230 can perform imaging and project an image onto the projection medium 1, and the projection medium 1 can present a projection image.

In some embodiments, the laser light source 210 of the apparatus 2 for projection can include a laser assembly and an optical lens assembly, and a light beam emitted from the laser assembly may pass through the optical lens assembly, thereby providing illumination for the light modulation assembly 220. For example, the optical lens assembly requires a higher level of environmental cleanliness and airtight level for sealing, but a chamber for installing the laser assembly may be sealed with a dust-proof level which is low in sealing level, so as to reduce a scaling cost.

In some embodiments, the light modulation assembly 220 of the apparatus 2 for projection may include a blue light modulation assembly, a green light modulation assembly, and a red light modulation assembly, and may further include a heat dissipation system, a circuit control system, and the like.

In some embodiments, a light-emitting portion of the projection device may further be implemented through an LED light source.

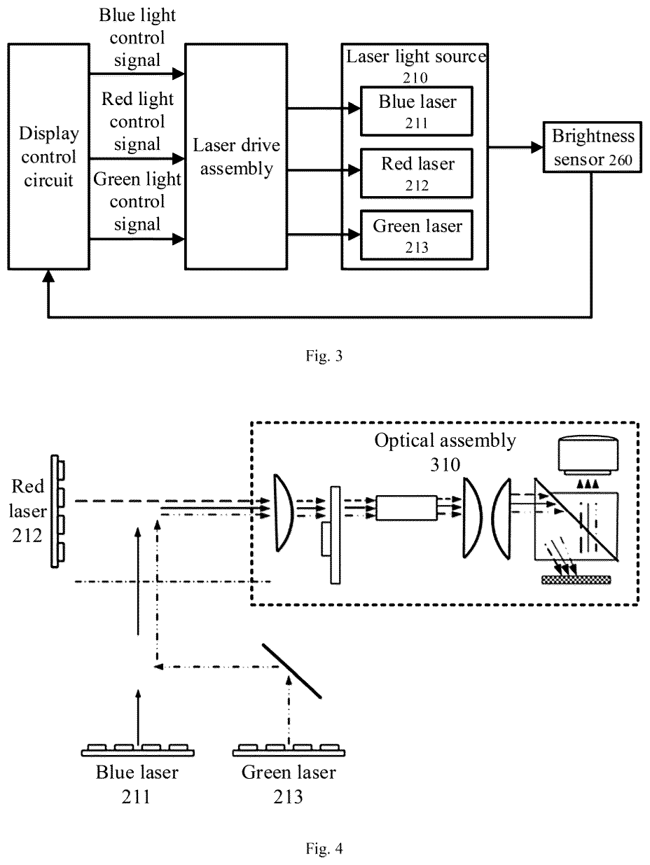

FIG. 3 shows a schematic diagram of a circuit architecture of a projection device. In some embodiments, an apparatus 2 for projection may include a display control circuit, a laser light source, at least one laser drive assembly, and at least one brightness sensor. The laser light source may include at least one laser in one-to-one correspondence to the at least one laser drive assembly. The “at least one” refers to one or more, and “a plurality of” refers to two or more.

Based on this circuit architecture, the projection device may achieve adaptive adjustment. For example, by arranging the brightness sensor in a light emission path of the laser light source 210, the brightness sensor 260 may detect a first brightness value of the laser light source and send the first brightness value to the display control circuit. The display control circuit may acquire a second brightness value corresponding to a driving current of each laser, and may determine that the laser has a catastrophic optical damage (COD) fault when it is determined that a difference value between the second brightness value of the laser and the first brightness value of the laser is greater than a difference value threshold. Thus, the display control circuit may adjust a current control signal of the laser drive assembly corresponding to the laser until the aforementioned difference value is less than or equal to the threshold, thereby eliminating the COD fault of the laser. The projection device can eliminate the COD fault of the laser in time, decrease a damage rate of the laser, and improve an image display effect of the projection device.

In some embodiments, referring to FIG. 4, the laser light source 210 in the apparatus 2 for projection may include an optical assembly 310, as well as a blue laser 211, a red laser 212, and a green laser 213 which are independently arranged. The projection device may also be referred to as a tricolor projection device. The blue laser 211, the red laser 212, and the green laser 213 are all module lightweight (Mirai Console Loader, MCL) encapsulated lasers, with a small volume that facilitates compact arrangement of the light path.

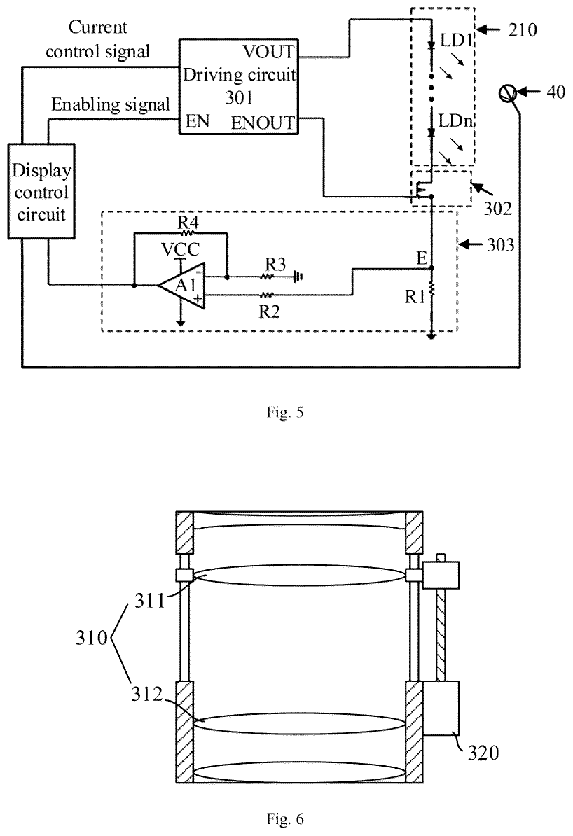

FIG. 5 shows a schematic structural diagram of a circuit of a projection device according to some embodiments of the disclosure.

In some embodiments, a laser drive assembly may include a driving circuit 301, a switching circuit 302, and an amplification circuit 303. The driving circuit 301 may be a driving chip. The switching circuit 302 may be a metal-oxide-semiconductor (MOS) transistor.

The driving circuit 301 is connected with the switching circuit 302, the amplification circuit 303, and a corresponding laser included in a laser light source 210 respectively. The driving circuit 301 is used for outputting a driving current to the corresponding laser in the laser light source 210 through a VOUT end based on a current control signal sent from a display control circuit, and transmitting a received enable signal to the switching circuit 302 through an ENOUT end.

The display control circuit can be further used for determining an amplified driving voltage as the driving current of the laser and acquiring a second brightness value corresponding to the driving current.

In some embodiments, the amplification circuit 303 may include: a first operational amplifier A1, a first resistor (also referred to as a sampling power resistor) R1, a second resistor R2, a third resistor R3, and a fourth resistor R4.

In some embodiments, the display control circuit can be further used for restoring the current control signal of the laser drive assembly corresponding to the laser to an initial value when a difference value between the second brightness value of the laser and a first brightness value of the laser is less than or equal to a difference value threshold. The initial value can be a magnitude of a PWM current control signal of the laser in a normal state. Therefore, when a COD fault occurs in the laser, it can be quickly recognized, a measure of reducing the driving current may be taken in a timely manner to reduce continuous damage of the laser itself and help it restore. The entire process does not require disassembly or human interference, thereby improving use reliability of a laser light source and ensuring projection display quality of the laser projection device.

In some embodiments, an apparatus 2 for projection includes a controller, and the controller is connected with relevant hardware of the projection device, such as the display control circuit, a brightness sensor, a distance sensor, and an image collection device, for controlling the embodiment of functions such as projection, focusing, correction, blocking object detection, blocking object prompt, and screen on/off state adjustment of the projection device.

In some embodiments, a body of the projection device may be provided with several types of interfaces, such as a power interface, a USB interface, a high definition multimedia interface (HDMI), a cable interface, a video graphics array (VGA) interface, and a digital visual interface (DVI), etc., to connect a signal source used for transmitting media.

In some embodiments, the projection device may directly enter a display interface of a last selected signal source or a signal source selection interface after startup, wherein the signal source, for example, is a preset video on demand program, and may further be one of the signal sources such as the HDMI, the USB interface, and a live television interface, etc. After a user selects a target signal source, the apparatus 2 for projection may acquire media data from the target signal source and project the media data onto a projection medium 1 for display.

In some embodiments, the apparatus 2 for projection may be configured with the image collection device for collaborative operation with the projection device to realize adjustment and control of a projection process. For example, the projection device may be configured with a camera such as a 3D camera, and a monocular or binocular camera, wherein the camera may be used for photographing images displayed in a projection surface, and may be a webcam. The webcam may include a lens assembly, and the lens assembly can be provided with a photosensitive element and a lens. The lens allows light of a scene's image to shine on the photosensitive element through refraction of the light via a plurality of lenses. The photosensitive element may be selected based on a detection principle of a charge coupled device or a complementary metal oxide semiconductor according to specifications of the camera. A light signal is converted into an electrical signal through a photosensitive material, and the converted electrical signal is output as image data.

FIG. 6 shows a schematic structural diagram of a lens of an apparatus 2 for projection in some embodiments. In order to support an automatic focusing process of the apparatus 2 for projection, as shown in FIG. 6, the lens 300 of the apparatus 2 for projection may further include an optical assembly 310 and a driving motor 320. The optical assembly 310 is a lens group comprising one or more lenses, and may refract light emitted by a light modulation assembly 220, so that the light emitted by the light modulation assembly 220 can be transmitted on a projection surface to form a transmitted content image.

The optical assembly 310 may include a lens cone and a plurality of lenses arranged in the lens cone. According to whether a position of the lens can be moved, the lens in the optical assembly 310 may be divided into a movable lens 311 and a fixed lens 312. By changing a position of the movable lens 311 to adjust a distance between the movable lens 311 and the fixed lens 312, an overall focal length of the optical assembly 310 is changed. Therefore, the driving motor 320 may drive the movable lens 311 to move its position by being connected with the movable lens 311 in the optical assembly 310, achieving an automatic focusing function.

It should be noted that the focusing process described in some embodiments of the disclosure refers to adjusting the distance between the movable lens 311 and the fixed lens 312, that is, adjusting an image plane position, by changing the position of the movable lens 311 through the driving motor 320. Therefore, an imaging principle of a lens combination in the optical assembly 310 is that adjusting the focal length is actually adjusting an image length. However, in terms of an overall structure of the optical assembly 310, adjusting the position of the movable lens 311 is equivalent to adjusting the overall focal length of the optical assembly 310.

When distances between the apparatus 2 for projection and the projection surface are different, the lens of the apparatus 2 for projection needs to be adjusted to different focal lengths to transmit a clear image on the projection surface. In the projection process, a spacing distance between the apparatus 2 for projection and the projection surface will require different focal lengths depending on different placement positions of the user. Therefore, in order to adapt to different usage scenarios, the apparatus 2 for projection needs to adjust the focal length of the optical assembly 310.

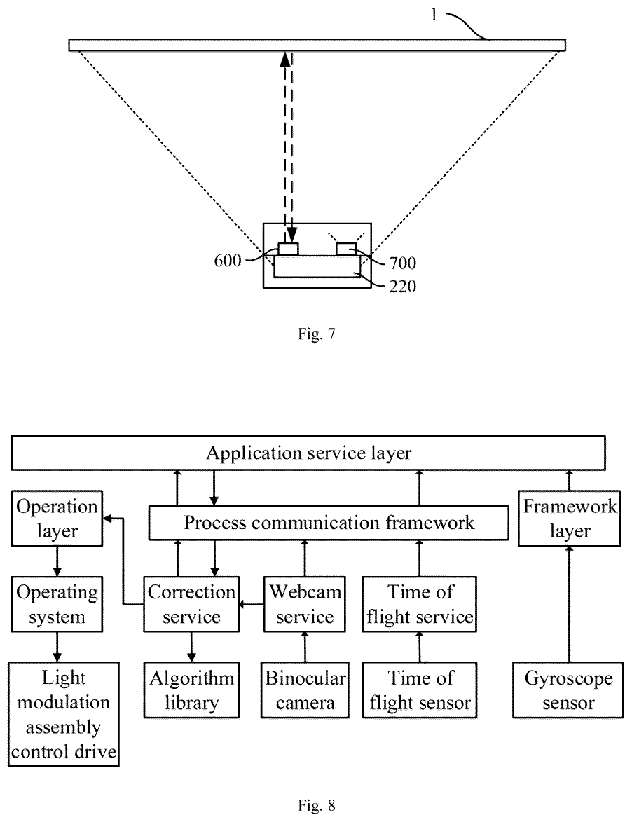

FIG. 7 shows a schematic structural diagram of a distance sensor and a camera in some embodiments. As shown in FIG. 7, the apparatus 2 for projection may include a light modulation assembly 220, a projection medium 1, and a distance sensor 600, and may further be internally provided with or externally connected with a camera 700, and the camera 700 may photograph images of the picture projected by the apparatus 2 for projection to acquire a projection image. The apparatus 2 for projection then performs clarity detection on the projection content image to determine whether a current focal length of the lens is appropriate, and adjusts the focal length when it is not appropriate. When performing automatic focusing based on the projection image photographed by the camera 700, the apparatus 2 for projection may continuously adjust a position of the lens and photograph, and find a focusing position by comparing clarity of pictures in front and rear positions, thereby adjusting the movable lens 311 in the optical assembly 310 to the appropriate position. For example, a controller 500 may first control a driving motor 320 to gradually move a focusing start position of the movable lens 311 to a focusing end position, and continuously acquire the projection image through the camera 700 during this period. By performing the clarity detection on the plurality of projection images, a position with the highest clarity is determined. Finally, the driving motor 320 is controlled to adjust the movable lens 311 from the focusing end position to the position with the highest clarity, completing automatic focusing.

When arranging a binocular camera on a projection device, a left camera (a first camera) and a right camera (a second camera) are included according to an installation position of the binocular camera on a first plane of the device. When the binocular camera is not obstructed, images of the projection medium 1 presenting the projection image may be simultaneously collected. If at least one camera in the binocular camera is obstructed, there is no projection content present in the image(s) photographed by the obstructed camera. For example, if a blocking object is red, the obstructed camera may collect a pure red image. The first plane is a plane, parallel and opposite to the projection surface of the projection medium 1, in a shell plane of the apparatus 2 for projection.

In some embodiments, FIG. 8 illustrates a schematic diagram of a system framework of a projection device for implementing display control, including an application service layer, a process communication framework, an operation layer, a framework layer, a correction service, a webcam service, a time of flight service, hardware and its driver, and the like.

The application service layer can be used for realizing interaction between the projection device and a user. Based on display of a user interface, the user may configure various parameters and display pictures of the projection device, and a controller may coordinate and call algorithm services corresponding to various functions to realize a function that the projection device automatically corrects its display picture in a case of abnormal display.

The service layer may include the correction service, the webcam service, the time of flight (TOF) service and other content. The services may focus upwards on the application service layer (APK Service) to achieve specific functions corresponding to different service configurations of the projection device; and the service layer links downwards with data collection services such as an algorithm library, a camera, and a time of flight sensor, etc., to achieve functions of encapsulating a complex underlying logic and transmitting service data to the corresponding service layer.

The underlying algorithm library may provide a correction service and a control algorithm for the projection device to achieve various functions. The algorithm library may, for example, complete various mathematical operations based on OpenCV to provide a basic capability for the correction service. OpenCV is a cross-platform computer vision and machine learning software library distributed under a BSD (Berkeley Software Distribution) license (open source), and may run on operating systems such as Linux, Windows, Android, and Mac OS, etc.

An apparatus 2 for projection has the characteristic of long focus and micro projection. The controller can control the overall system architecture and implements projection control of the projection device based on the underlying program logic, including but not limited to automatic keystone correction of the projection image, automatic screen entry, automatic obstacle avoidance, automatic focusing, eye-irradiation preventing, blocking object detection, blocking object prompt, screen on-off control, and other functions.

In some embodiments, the apparatus 2 for projection can be equipped with a gyroscope sensor. During movement of the projection device, the gyroscope sensor may sense displacement of the projection device and actively collect position data; then, send the collected position data to the application service layer through the framework layer to support application data required during user interface interaction and application interaction. The position data may further be used for data calling by the controller in algorithm service implementation.

In some embodiments, the apparatus 2 for projection is further equipped with a distance sensor for detecting a distance. The distance sensor may use a time of flight (TOF) sensor, and the time of flight sensor measures a distance between nodes using round-trip time of flight of a signal between a transmitting end and a reflecting end. After collecting distance data, the time of flight sensor sends the distance data to a time of flight service. After acquiring the distance data, the time of flight service sends the collected distance data to the application service layer through the process communication framework. The distance data will be used for controller data calling, user interface, program application interaction, and serve as first reference data for blocking object detection.

In some embodiments, the apparatus 2 for projection may also be equipped with an image collection device, and the image collection device may use a binocular camera, a depth camera, or a 3D camera. The image collection device sends the collected image data to the webcam service, the webcam service then sends the image data to the process communication framework and/or the correction service. The process communication framework sends the image data to the application service layer, and the image data will be used for controller data calling, user interface, program application interaction, and serve as second reference data for blocking object detection.

In some embodiments, the process communication framework can exchange data with the application service, and then a projection correction parameter is fed back to the correction service through the process communication framework. The correction service sends the projection correction parameter to an operation layer of the projection device, and the operating system generates a correction command according to the projection correction parameter, and issues a correction signaling to a light modulation assembly drive module, so that the light modulation assembly drive module adjusts a working condition of the light modulation assembly according to the projection correction parameter and completes the automatic correction of the projection image.

In some embodiments, when the correction command is detected, the projection device may correct the projection image. An association relationship among the distance, a horizontal included angle, and an offset angle may be created in advance, and then the controller of the projection device determines a target included angle between the light modulation assembly and the projection medium 1 at the current moment in combination with the belonged association relationship by acquiring a current distance from the light modulation assembly to the projection medium 1, so as to achieve projection image correction. The specific embodiment of the target included angle is an included angle between a central axis of the light modulation assembly and the projection surface of the projection medium 1.

In some embodiments, the projection device may refocus after automatic correction is completed, and the controller can detect whether the automatic focusing function is activated. If the automatic focusing function is not activated, the controller will end the automatic focusing service. If the automatic focusing function is activated, the controller can perform focusing calculation based on a distance detection value of the time of flight sensor.

In some embodiments, the controller can query a preset mapping table according to the distance detection value of the time of flight sensor, the preset mapping table records a mapping relationship between the distance and the focal length, and thus the focal length of the projection device corresponding to the distance detection value is acquired. Then middleware issues the acquired focal length to the light modulation assembly of the projection device. After the light modulation assembly emits laser according to the above focal length, at least one camera photographs the projection content image. The controller performs clarity detection on the projection content image to determine whether the current focal length of the lens is appropriate. If the focal length is not appropriate, focusing processing needs to be performed. The projection device adjusts the position of the lens and photographs, and compares the clarity changes of the projected content image before and after the adjustment to locate the focusing position with the highest clarity.

If a determination result meets a preset completion condition, an automatic focusing process is controlled to end. If the determination result does not meet the preset completion condition, the middleware will finely tune the focal length parameter of the light modulation assembly of the projection device, for example, the middleware gradually and finely tunes the focal length according to a preset step length, and sets the adjusted focal length parameter to the light modulation assembly again. Through multiple photographing, clarity evaluation, and other steps, the optimal focal length is finally locked through the clarity comparison of the projection image, thus completing automatic focusing.

In some embodiments, the first plane of the projection device is at least provided with the lens, the distance sensor, and the image collection device, and the image collection device may include one or more cameras. The first plane is a plane, parallel and opposite to the projection plane, on the apparatus 2 for projection during projection.

In some embodiments, referring to the first plane structure illustrated in FIG. 9, a first measurement assembly and a second measurement assembly 250 are arranged on the first plane. The first measurement assembly includes a first camera 241, and the second measurement assembly 250 includes a second camera 251 and a distance sensor 252. The first measurement assembly is arranged at the first position (corresponding to a left side region of the first plane) of the first plane, the second measurement assembly 250 is arranged at the second position (corresponding to a right side region of the first plane) of the first plane, the first camera 241 and the second camera 251 are included in the image collection device, and the first camera 241 and the second camera 251 should have a certain distance interval. The position of the first measurement assembly and the second measurement assembly 250 on either side of the first plane does not affect the essence of this embodiment.

In some embodiments, referring to FIG. 9, the lens 230 in a projection assembly and the first camera 241 are on the same side on the first plane, i.e. both are located on a left side of the first plane, and a spacing between the lens 230 and the first camera 241 is small, resulting in a compact positional relationship. Similarly, the spacing between the second camera 251 and the distance sensor 252 is small, resulting in compact position.

In some embodiments, center points of the lens 230, the first camera 241, the second camera 251, and the distance sensor 252 may be set to be of equal height.

In some embodiments, the distance sensor 252 may use a TOF sensor or other sensors for detecting the distance; and the first camera 241 and the second camera 251 may use a 3D camera, a depth camera, etc.

In some embodiments, based on the projection device structure illustrated in FIG. 9, there may be four types of blocking scenarios as follows.

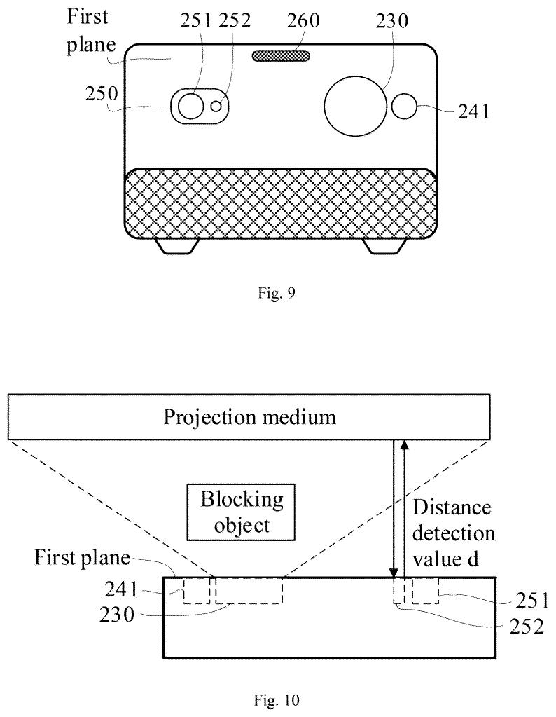

A first blocking scenario: referring to an example in FIG. 10, the blocking object is relatively small, and a blocking object range only covers the left side region of the first plane, that is, only the lens 230 and the first camera 241 are obstructed, while the second camera 251 and the distance sensor 252 on the right side are not obstructed.

A second blocking scenario: referring to an example in FIG. 11, the blocking object is relatively small, and the blocking object range only covers the right side region of the first plane, that is, only the second camera 251 and the distance sensor 252 on the right side are obstructed, while the lens 230 and the first camera 241 on the left side are not obstructed.

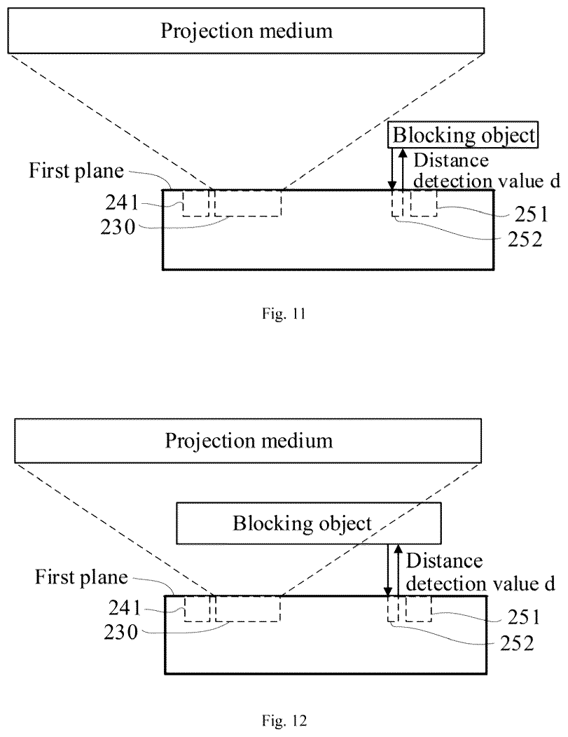

A third blocking scenario: referring to an example in FIG. 12, the blocking object is relatively large, and the blocking object range covers the left side and the right side of the first plane, that is, the lens 230, the first camera 241, the second camera 251, and the distance sensor 252 are all obstructed.

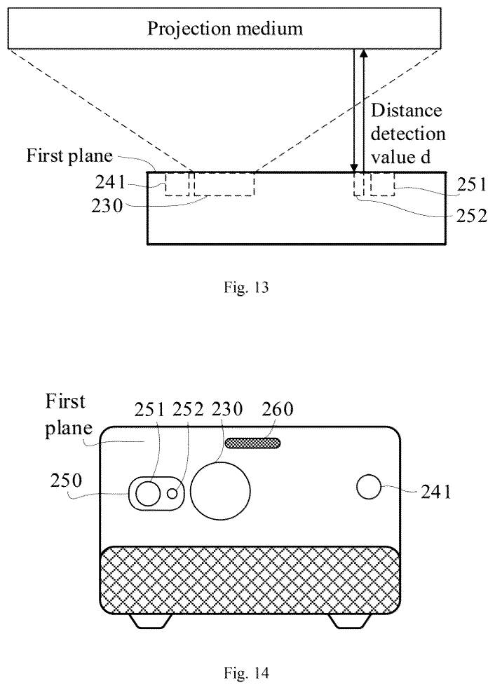

A fourth blocking scenario: referring to an example in FIG. 13, there is no any blocking object in front of the projection device, that is, the lens 230, the first camera 241, the second camera 251, and the distance sensor 252 are all not obstructed. For the first blocking scenario and the third blocking scenario above, because the lens 230 is obstructed, on the one hand, the projection display of the media data will be affected, and on the other hand, a high temperature of the light projected by the lens 230 can easily cause high-temperature burns to the blocking object, and fire hazards may even be caused especially when an ignition point of the blocking object is low, resulting in a safety hazard. For the second blocking scenario above, although the lens 230 is not obstructed, the distance sensor 252 is obstructed, which will result in the projection device being unable to be accurately self-corrected. It can be seen from this that it is necessary to perform blocking object detection on the projection device and prompt the user to remove the blocking object in time.

In some embodiments, when the controller receives a power-on broadcast or a standby broadcast (the standby broadcast includes a suspend to RAM (STR) broadcast), the distance sensor 252 is used for distance detection. If the second blocking scenario and the third blocking scenario are met, the signal emitted by the distance sensor 252 will be reflected back when encountering the blocking object midway, resulting in a smaller distance detection value. If the fourth blocking scenario is met, the signal emitted by the distance sensor 252 will be reflected back by the projection medium 1. The distance detection value in this scenario is equal to a projection distance L, and the projection distance L is a spacing distance between the projection surface and the light modulation assembly.

Therefore, when acquiring the distance detection value of the distance sensor 252, the controller compares the distance detection value with a preset distance threshold. If the distance detection value is less than or equal to the distance threshold, the second blocking scenario may be met, that is, the lens 230 is not obstructed, and the distance sensor 252 is obstructed. In this scenario, although projection light emitted by the lens 230 does not burn the blocking object, the blocking object will affect the automatic correction of the projection device, and therefore, the projection device needs to prompt to remove the blocking object. Alternatively, if the distance detection value is less than or equal to the distance threshold, the third blocking scenario may be met, that is, the lens 230 and the distance sensor 252 are both obstructed, which not only affects the automatic correction of the projection device, but also causes the blocking object to be burned by the projection light with the high temperature. Therefore, it is also necessary to prompt to remove the blocking object. The distance threshold is greater than 0 and less than L, and L represents the distance between the lens 230 and the projection surface of the projection medium 1, namely, the projection distance. The distance threshold may be set based on a safe distance between the lens and the blocking object, that is, the threshold is set with the aim of avoiding the risk of high-temperature burns to the blocking object by the projection light emitted by the lens. For example, if the safe distance is 10 cm, which means that the blocking object in a region less than 10 cm will be burned by the projection light, the distance threshold is set to be greater than or equal to this safe distance.

In some embodiments, if the distance detection value is less than or equal to the distance threshold, the controller can control the projection device to prompt to remove the blocking object, and records that the projection device is in a state with the blocking object.

In some embodiments, referring to FIG. 9, the projection device may be equipped with a voice player 260 and output prompt information through the voice player 260. The prompt information is, for example, “please remove the blocking object in front of the projection device as soon as possible”. Alternatively, the projection device can control the display of text information for prompting to remove the blocking object on the projection image of the projection medium 1. Alternatively, the projection device may push the prompt information to communicable associated electronic devices, such as a smartphone, a tablet computer, and a computer, ect. A prompt manner for removing the blocking object by the projection device is not limited to the example of the disclosure.

In some embodiments, a blocking object state flag bit may be set in a system of the projection device, and is used for recording and indicating the blocking object state of the projection device. The blocking object state includes a state without the blocking object and the state with the blocking object. The state with the blocking object is used for indicating the presence of the blocking object between the projection device and the projection surface, and the state without the blocking object is used for indicating the absence of the blocking object between the projection device and the projection surface. For example, if a state value of the blocking object state flag bit is set to be 0, it represents the state without the blocking object, and if the state value of the blocking object state flag bit is set to be 1, it represents the state with the blocking object.

In some embodiments, if the distance detection value is less than or equal to the distance threshold, the blocking object state flag bit is recorded as the state with the blocking object, and the projection device prompts to remove the blocking object. After the user removes the blocking object, the projection device detects that there is no blocking object in front of the projection device (i.e. meeting the fourth blocking scenario), and updates the state value of the blocking object state flag bit to change the blocking object state to the state without the blocking object. The projection device needs to synchronously change the state value recorded by the blocking object state flag bit when detecting the presence of the blocking object or removal of the blocking object.

In some embodiments, if the distance detection value is less than or equal to the distance threshold, the second blocking scenario or the third blocking scenario may be generated. To determine which specific type of blocking scenario it is, the controller may start the first camera 241 and the second camera 251 to acquire the first image collected by the first camera 241 and acquire the second image collected by the second camera 251, and compare the first image and the second image.

For the second blocking scenario, the second camera 251 and the distance sensor 252 on the right side are obstructed, while the lens 230 and the first camera 241 on the left side are not obstructed. Therefore, the first image is a normally collected projection image. Due to the short distance between the lens of the second camera 251 and the blocking object, the picture refracted by the light from the lens of the second camera 251 is different from the first image. For example, if the blocking object is black, the second image presents as a pure black image, and a similarity between the first image and the second image in this scenario is low.

For the third blocking scenario, due to the fact that the lens 230, the first camera 241, the second camera 251, and the distance sensor 252 are all obstructed by the same blocking object, and the color and texture of the surface of the blocking object are similar or consistent, the similarity between the first image and the second image photographed in this scenario is high.

In some embodiments, when the distance detection value is less than or equal to the distance threshold, the controller further calculates the similarity between the first image and the second image, and compares this similarity with a preset similarity threshold. If the similarity is greater than or equal to the similarity threshold, it is considered that the similarity between the first image and the second image is high, and it is determined that the current scenario is the third blocking scenario. If the similarity is less than the similarity threshold, it is considered that the similarity between the first image and the second image is low, and it is determined that the current scenario is the second blocking scenario.

In some embodiments, if the controller determines that the second blocking scenario is generated, as the lens 230 is not obstructed in this scenario, that is, there is no safety risk of the light with the high temperature burns to the blocking object, and only a problem of the projection device being unable to be accurately self-corrected due to the blocking object of the distance sensor 252 exists. Therefore, it is only necessary to control the projection device to prompt to remove the blocking object and record the state with the blocking object in the blocking object state flag bit.

In some embodiments, if the controller determines that the third blocking scenario is generated, both the lens 230 and the distance sensor 252 are obstructed in this scenario, which not only affects the automatic correction of the projection device, but also burns the blocking object due to the light with the high temperature emitted by the lens 230. Therefore, the controller can control the projection device to prompt to remove the blocking object, so that the blocking object state flag bit records the state with the blocking object, and a screen-off protection operation is performed on the projection device, that is, the projection assembly is controlled to pause projecting the media data to the projection medium 1, so that the lens 230 no longer emits the projection light, thereby preventing the projection light from burning the blocking object before removing the blocking object.

In some embodiments, the controller may control the distance sensor 252 to measure the distance detection value every preset duration interval, and immediately turn off the distance sensor 252 after the detection is completed to reduce system resource consumption of the projection device. Based on the previous embodiment, if the controller detects that there is no blocking object in front of the projection device, that is, the user has removed the blocking object, a screen-on operation is performed on the projection device, that is, the situation that the projection assembly projects the media data to the projection medium 1 is restored, and the record of the blocking object state flag bit is changed to the state without the blocking object.

In some embodiments, for the first blocking scenario, the blocking object only covers the first position (the left side of the first plane in the second perspective of FIG. 10) of the first plane, that is, the lens 230 is obstructed, and the distance sensor 252 is not obstructed, so that the signal emitted by the distance sensor 252 reaches the projection medium 1 directly before being transmitted back, resulting in the distance detection value measured by the distance sensor 252 being greater than the distance threshold. For the fourth blocking scenario, there is no blocking object in front of the projection device, which will not obstruct the lens 230 and the distance sensor 252. Similarly, the signal emitted by the distance sensor 252 is transmitted back only after directly reaching the projection medium 1, rather than being emitted by the blocking object in the midway, so the distance detection value is greater than the distance threshold in this scenario.

In some embodiments, if the distance detection value is greater than the distance threshold, the first blocking scenario or the fourth blocking scenario may be generated. To determine which specific type of blocking scenario it is, the controller may start the first camera 241 and the second camera 251 to acquire the first image collected by the first camera 241 and acquire the second image collected by the second camera 251, and compare the first image and the second image.

For the first blocking scenario, the lens 230 and the first camera 241 on the left side are obstructed, while the second camera 251 and the distance sensor 252 on the right side are not obstructed. Therefore, the second image is a normally collected projection image. Due to the short distance between the lens of the first camera 241 and the blocking object, the image refracted by the light from the lens of the first camera 241 is different from the second image. For example, if the blocking object is white, the second image presents as a pure white image, and the similarity between the first image and the second image in this scenario is low.

For the fourth blocking scenario, because there is no blocking object in front of the first plane, the lens 230, the first camera 241, the second camera 251, and the distance sensor 252 are not obstructed. The first camera 241 and the second camera 251 collect images of the projection image presented on the same projection medium 1, so the similarity between the first image and the second image is high.

In some embodiments, when the distance detection value is greater than the distance threshold, the controller further calculates the similarity between the first image and the second image, and compares this similarity with the preset similarity threshold. If the similarity is greater than or equal to the similarity threshold, it is considered that the similarity between the first image and the second image is high, and it is determined that the current scenario is the fourth blocking scenario. If the similarity is less than the similarity threshold, it is considered that the similarity between the first image and the second image is low, and it is determined that the current scenario is the first blocking scenario.

In some embodiments, if the controller determines that the fourth blocking scenario is generated, because there is no blocking object in front of the projection device in this scenario, there is no problem of burning the blocking object by the projection light, nor is there interference from the blocking object with the automatic correction of the projection device. Therefore, the projection device does not need to prompt information of removing the blocking object, so that the blocking object state flag bit records the state without the blocking object, and the projection device can run normally.

In some embodiments, if the controller determines that the first blocking scenario is generated, the lens 230 is obstructed in this scenario, and the blocking object may be burnt by the projection light with the high temperature emitted by the lens 230. Therefore, the controller can control the projection device to prompt to remove the blocking object, so that the blocking object state flag bit records the state with the blocking object, and a screen-off protection operation is performed on the projection device, that is, the projection assembly is controlled to pause projecting the media data to the projection medium 1, so that the lens 230 stops emitting the projection light, thereby preventing the projection light from burning the blocking object before removing the blocking object.

In some embodiments, the controller detects that there is no blocking object in front of the projection device, that is, when it determines that the fourth blocking scenario is met, the state value recorded by the blocking object state flag bit is queried. If the blocking object state flag bit currently indicates the state with the blocking object and the projection device is in the screen-off protection state, it indicates that the user removes the blocking object in the first blocking scenario or the third blocking scenario. Then, the screen-on operation is performed on the projection device, so that the projection assembly restores to project the media data to the projection medium 1, and changes the record of the blocking object state flag bit to the state without the blocking object. If the blocking object state flag bit currently indicates the state without the blocking object and the projection device is in the screen-on state, it indicates that there has been no blocking object in front of the projection device and the normal running state of the projection device is maintained. If the blocking object state flag bit currently indicates the state with the blocking object and the projection device is in the screen-on state, it indicates that the user removes the blocking object in the second blocking scenario. The record of the blocking object state flag bit is changed to the state without the blocking object to maintain the normal running state of the projection device.

In some embodiments, the similarity between the first image and the second image may be compared by using algorithms such as a cosine distance and a statistical histogram. The cosine distance is to compare a degree of similarity between the first image and the second image, and the statistical histogram algorithm analyzes image features to determine which image collection device or apparatuses are obstructed.

In some embodiments, regardless of which side or sides of the first plane are covered by the blocking object, i.e., for any scenario in the first blocking scenario, the second blocking scenario, and the third blocking scenario, as long as the blocking object in front of the projection device is detected, a prompt to remove the blocking object may be implemented, and the screen-off protection may be performed on the projection device.

In some embodiments, FIG. 14 illustrates a first plane structure of another projection device, a first measurement assembly and a second measurement assembly 250 are arranged on a first plane, the first measurement assembly includes a first camera 241, and the second measurement assembly 250 includes a second camera 251 and a distance sensor 252. The difference from FIG. 9 is that a lens 230 in a projection assembly and the second measurement assembly 250 are on the same side on the first plane, that is, the lens 230, the second camera 251, and the distance sensor 252 are all located at a second position (a right side region) of the first plane and are close to each other, while the first camera 241 is separately located at a first position (a left side region) of the first plane. The position of the first measurement assembly and the second measurement assembly 250 on either side of the first plane does not affect the essence of this solution.

In some embodiments, based on the projection device structure illustrated in FIG. 14, there may be four types of blocking scenarios as follows.

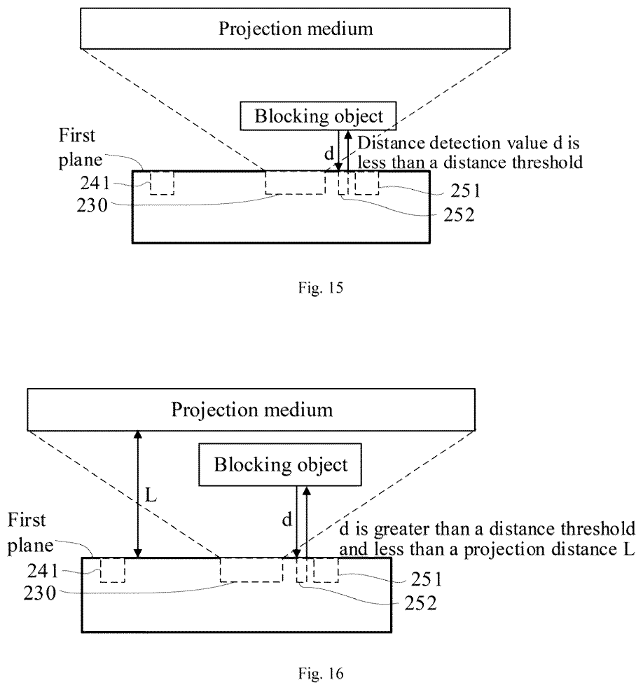

A fifth blocking scenario: referring to an example in FIG. 15, the blocking object only covers the right side region of the first plane, that is, the lens 230, the second camera 251, and the distance sensor 252 are all obstructed, the first camera 241 is not obstructed, and a distance detection value is less than or equal to a distance threshold. In the fifth blocking scenario, the distance between the lens 230 and the blocking object does not exceed the distance threshold, which can easily cause the blocking object to be burned by the high temperature of the projection light. Therefore, the controller can control the projection device to prompt to remove the blocking object, so that the blocking object state flag bit records the state with the blocking object, and a screen-off protection operation is performed on the projection device, that is, the projection assembly is controlled to pause projecting the media data to the projection medium 1, so that the lens 230 stops emitting the projection light, thereby preventing the projection light from burning the blocking object before removing the blocking object.

A sixth blocking scenario: referring to an example in FIG. 16, the blocking object only covers the right side of the first plane, that is, the lens 230, the second camera 251, and the distance sensor 252 are all obstructed, and the first camera 241 is not obstructed. Assuming that the distance detection value is d, the scenario meets that d is greater than the distance threshold and less than a projection distance L. Since the distance between the lens 230 and the blocking object exceeds the distance threshold, there is no risk of burning the blocking object by the high temperature of the projection light. However, blocking object of the distance sensor 252 by the blocking object may cause the projection device to be unable to automatically correct and focus. Therefore, the controller can control the projection device to prompt to remove the blocking object, so that the blocking object state flag bit records the state with the blocking object, but the projection device can still be kept in a screen-on state. In a case of not moving the apparatus 2 for projection and the projection medium 1, the projection distance L remains as a fixed value.

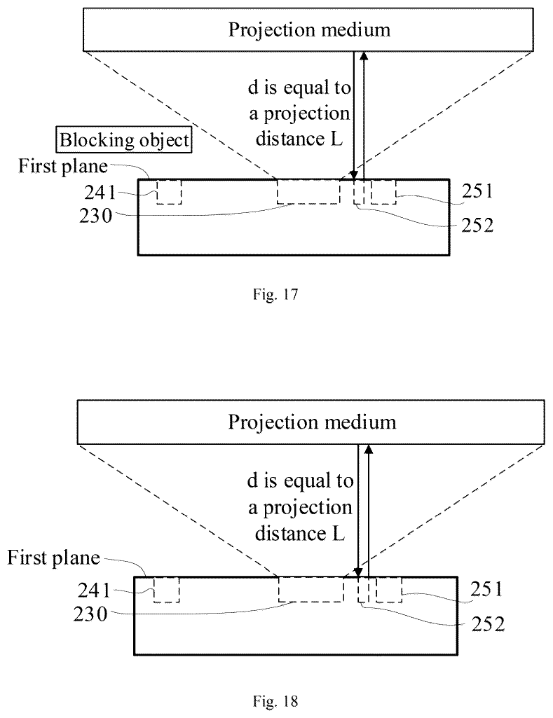

When d is equal to the projection distance L, there are two possible scenarios. In a seventh blocking scenario illustrated referring to FIG. 17, the blocking object only covers the left side of the first plane, that is, only the first camera 241 is obstructed, and the lens 230, the second camera 251, and the distance sensor 252 are all not obstructed. In an eighth blocking scenario illustrated referring to FIG. 18, there is no any blocking object on a projection path of the projection light. In the seventh blocking scenario and the eighth blocking scenario, the lens 230, the distance sensor 252, and the second camera 251 on the right side of the first plane are all not obstructed, which does not affect the automatic correction and focusing of the projection device, nor does it pose a risk of burning the blocking object by the high temperature of the projection light. Therefore, when the distance detection value d is equal to the projection distance L, it is considered that there is no blocking object in front of the projection device, and the controller does not need to prompt to remove the blocking object, so that the blocking object state flag bit records the state without the blocking object.

The projection device shown in FIG. 14 is a structure of a binocular camera. As a variant of FIG. 14, the projection device may also be a monocular camera structure. For example, the first camera 241 is omitted, and only a single measurement assembly is arranged on the first plane. The measurement assembly includes an image collection device and a distance sensor, and the measurement assembly may be arranged at any position on the first plane. The lens 230 is located close to the measurement assembly, and its blocking object detection mechanism is basically the same as the binocular camera structure shown in FIG. 14, which will not be repeated here. A blocking object detection mechanism of the projection device shown in FIG. 14 mainly relies on the distance detection value measured by the distance sensor 252, without the need for similarity analysis of images collected by dual cameras. For the fifth blocking scenario or the sixth blocking scenario, as long as the distance detection value d is less than the projection distance L, the prompt to remove the blocking object may be implemented, and the screen-off protection is performed on the projection device.

In the disclosure, FIG. 10, FIG. 11, FIG. 12, FIG. 13, FIG. 15, FIG. 16, FIG. 17, and FIG. 18 present the first perspective, while FIG. 9 and FIG. 14 present the second perspective. The first perspective and the second perspective are opposite, and the sides corresponding to the first position and the second position on the first plane are opposite in both perspectives. The first perspective is an actual perspective of the projection device during use. Therefore, the disclosure defines a relative direction of the first position and the second position on the first plane based on the first perspective.

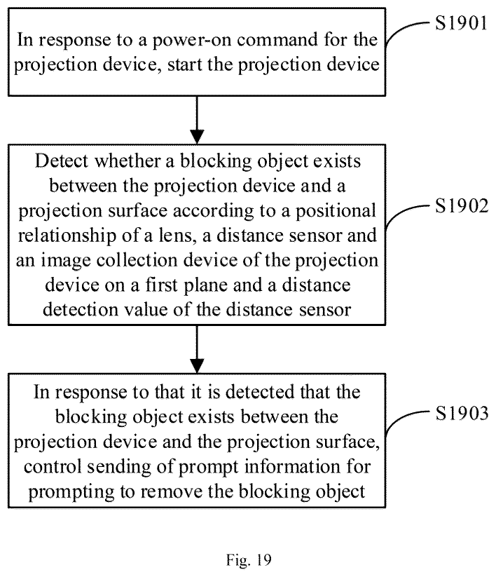

In some embodiments, FIG. 19 provides a first projection detection method. The method is executed by a controller of a projection device, and can include the following steps.

step S1901, in response to a power-on command for the projection device, starting the projection device.

Step S1902, detecting whether a blocking object exists between the projection device and a projection surface according to a positional relationship of a lens, a distance sensor, and an image collection device of the projection device on a first plane and a distance detection value of the distance sensor.

The first plane can be a plane on the projection device that is parallel to the projection surface during projection, and the projection surface is used for receiving and displaying projection content projected by a light modulation assembly.

Step S1903, based on that it is detected that the blocking object exists between the projection device and the projection surface, controlling sending of prompt information for prompting to remove the blocking object.

In this embodiment, the distribution and positional relationship of the lens 230, the distance sensor 252, and the image collection device on the first plane of the projection device are not limited, and whether the image collection device includes one or more cameras is also not limited. Therefore, a blocking object state of the projection device is detected on the basis of the positional relationship of relevant elements on the first plane of the projection device and in combination with the distance detection value of the distance sensor 252. When there is the blocking object, a user is promptly prompted to remove the blocking object to avoid a problem of abnormal working of the projection device caused by burning of the blocking object by projection light and blocking object of important elements, thereby improving a display effect of the projection content while ensuring safety. This embodiment realizes blocking object detection and can provide countermeasures based on structural characteristics of the projection device.

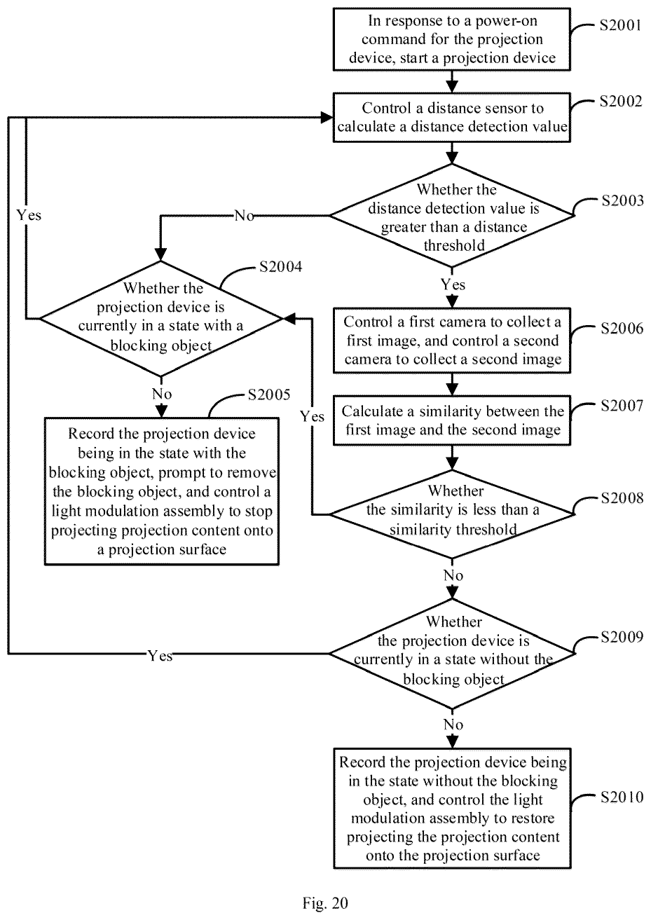

In some embodiments, based on a projection device illustrated in FIG. 9, FIG. 20 can provide a second projection detection method. The method can be executed by a controller of the projection device, and can include the following steps.

Step S2001, in response to a power-on command for the projection device, starting the projection device.

Step S2002, controlling a distance sensor to calculate a distance detection value.

Step S2003, determining whether the distance detection value is greater than a distance threshold. In response to the distance detection value being less than or equal to the distance threshold, the flow goes to step S2004; otherwise, the flow goes to step S2006 to step S2008.

Step S2004, determining whether the projection device is currently in a state with a blocking object. In response to that the projection device is currently in a state without the blocking object, that is, in response to that the projection device currently changes from absence of the blocking object to presence of the blocking object, the flow goes to step S2005. In response to that the projection device is currently in the state with the blocking object, that is, there is always the blocking object in front of the projection device, the flow goes to step S2002 to measure the distance detection value at regular intervals to detect whether the blocking object is removed.

Step S2005, recording the projection device being in the state with the blocking object, prompting to remove the blocking object, and controlling a light modulation assembly to stop projecting projection content onto a projection surface.

Step S2006, controlling a first camera to collect a first image, and controlling a second camera to collect a second image.

Step S2007, calculating a similarity between the first image and the second image.

Step S2008, determining whether the similarity is less than a similarity threshold. In response to that the similarity between the first image and the second image is less than the similarity threshold, it indicates the presence of the blocking object, and the flow goes to step S2004. In response to that the similarity between the first image and the second image is greater than or equal to the similarity threshold, it indicates the absence of the blocking object, and the flow goes to step S2009.

Step S2009, determining whether the projection device is currently in the state without the blocking object. In response to that the projection device is currently in the state with the blocking object, it indicates that the user has removed the blocking object, and then the flow goes to step S2010. In response to that the projection device is currently in the state without the blocking object, that is, there has been no blocking object in front of the projection device, the flow goes to step S2002 to measure the distance detection value at regular intervals to detect whether there is the blocking object.

Step S2010, recording the projection device being in the state without the blocking object, and controlling the light modulation assembly to restore projecting the projection content onto the projection surface.

In this method embodiment, the distance sensor is combined with a dual image collection device to recognize a type of a blocking scenario. If there is the blocking object, the projection device promptly prompts the user to remove the blocking object and can provide screen-off protection for the projection device, so as to improve use safety of the projection device, prevent the blocking object from being burned by projection light, avoid an impact of the blocking object on the display of a projection image, and avoid an abnormal problem of the projection device being unable to automatically correct and focus when key elements such as the distance sensor are obstructed. If the user removes the blocking object after receiving the prompt, the projection device will detect that the blocking object does not exist, and then turn on the screen and restore projecting media data to a projection medium.

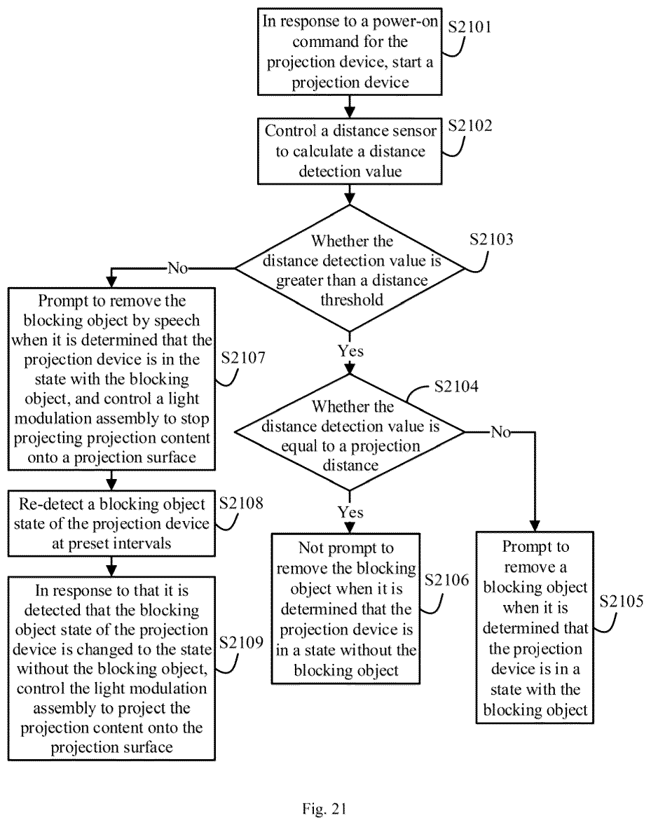

In some embodiments, based on a projection device illustrated in FIG. 14, FIG. 21 provides a third projection detection method. The method can be executed by a controller of the projection device, and can include the following steps.

Step S2101, in response to a power-on command for the projection device, starting the projection device.

Step S2102, controlling a distance sensor to calculate a distance detection value.

Step S2103, determining whether the distance detection value is greater than a distance threshold. In response to the distance detection value being greater than the distance threshold, the flow goes to step S2104; otherwise, in response to the distance detection value being less than or equal to the distance threshold, the flow goes to step S2107 to step S2109.

Step S2104, determining whether the distance detection value is equal to a projection distance.

The projection distance is a distance between a lens/a first plane and a projection medium. In response to the distance detection value being greater than the distance threshold and the distance detection value being less than the projection distance, the flow goes to step S2105; and in response to the distance detection value being equal to the projection distance, the flow goes to step S2106.

Step S2105, prompting to remove a blocking object when it is determined that the projection device is in a state with the blocking object.

Step S2106, not prompting to remove the blocking object when it is determined that the projection device is in a state without the blocking object.

Step S2107, prompting to remove the blocking object when it is determined that the projection device is in the state with the blocking object, and controlling a light modulation assembly to stop projecting projection content onto a projection surface.

Step S2108, re-detecting a blocking object state of the projection device at preset intervals.

Step S2109, based on that it is detected that the blocking object state of the projection device is changed to the state without the blocking object, controlling the light modulation assembly to project the projection content onto the projection surface.

Based on an example in FIG. 14, the projection device structure can be divided into three distance intervals according to the distance threshold and the projection distance. Within the interval A corresponding to (0 and distance threshold], due to the blocking object being close to the lens, the blocking object is prone to being burnt by projection light. Therefore, when the distance detection value is within the interval A, not only a prompt needs to be given to remove the blocking object, but also screen-off protection needs to be performed on the projection device. Within the interval B corresponding to (distance threshold and projection distance), because the blocking object is within a safe range and will not be burnt by the projection light, it is only needed to prompt to remove the blocking object without turning off a screen. When the distance detection value is equal to the projection distance, the projection light may directly reach the projection medium, so that the projection medium displays projected media data without encountering the blocking object, so there is no need to prompt to remove the blocking object. This embodiment may detect whether there is the blocking object according to the interval of the distance detection value, and determine response measures for the blocking object.

Based on the above examples in the disclosure, the position distribution features of the lens 230, the distance sensor, and at least one image collection device on the first plane may be set, and corresponding blocking object detection and coping mechanisms may be configured, which is not limited to the embodiments illustrated in the disclosure. In addition, software and hardware configuration and functions of the projection device are not limited. The embodiments of the disclosure are applicable to different types of projection devices, including a projector with long focus and micro projection characteristics. The projection medium referred to in the disclosure refers to a carrier that is projected and used for displaying the projection image, such as a wall, a fixed or movable screen, or an electronic device with a display capability, such as a computer, etc.

In some embodiments, the projection device and the obstacle avoidance projection detection method provided by the disclosure may further achieve an eye-irradiation preventing function. When it is detected that the user enters a range of an emitted laser trajectory, an eye-irradiation preventing switch is turned on and the user is reminded to leave the current region. The controller may further control a user interface to lower the display brightness to prevent laser damage to the user vision.

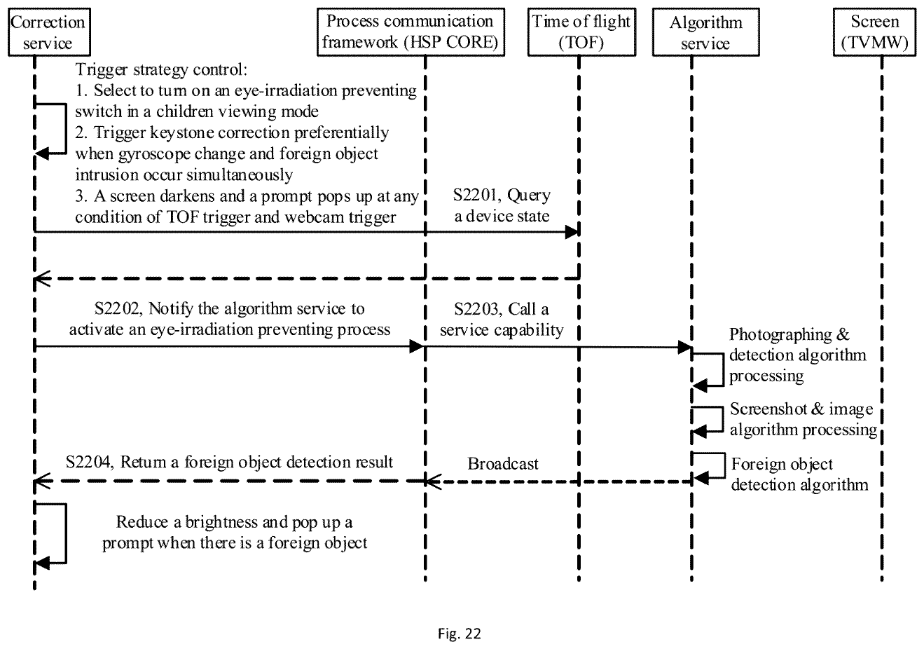

FIG. 22 shows a schematic diagram of a signaling interaction timing for realizing an eye-irradiation preventing function in a projection device according to another embodiment of the disclosure.

In some embodiments, when the projection device is configured as a child viewing mode, the controller will automatically turn on the eye-irradiation preventing switch.

In some embodiments, the controller will control the projection device to turn on the eye-irradiation preventing switch after receiving position movement data sent by a gyroscope sensor or foreign object invasion data collected by other sensors.

In some embodiments, when data collected by devices such as a time of flight (TOF) sensor and a webcam device triggers any preset threshold condition, the controller will control the user interface to reduce the display brightness, display prompt information, and reduce light modulation assembly transmission power, brightness, and intensity to achieve protection of the user vision.

In some embodiments, the controller of the projection device may control a correction service to send a signaling to the time of flight sensor, and at step S2201, query a current device state of the projection device, and then the controller receives data feedback from the time of flight sensor.

Step S2202, the correction service may send a notification algorithm service to a process communication framework (HSP Core) to initiate an eye-irradiation preventing process signaling.

step S2203, the process communication framework (HSP Core) will make service capability calling from an algorithm library to retrieve corresponding algorithm services, such as a photo-taking detection algorithm, a screenshot picture algorithm, and a foreign object detection algorithm.

step S2204, the process communication framework (HSP Core) returns foreign object detection results to the correction service based on the above algorithm services; and for the returned results, if a preset threshold condition is reached, the controller will control the user interface to display the prompt information and reduce the display brightness. The signaling timing is as shown in FIG. 22.

In some embodiments, when the eye-irradiation preventing switch of the projection device is turned on and the user enters a preset specific region, the projection device will automatically reduce the intensity of laser emitted by the light modulation assembly, lower the display brightness of the user interface, and display the safety prompt information. The control of the above eye-irradiation preventing function by the projection device may be achieved through the following methods.

The controller recognizes a projection region of the projection device by using an edge detection algorithm based on the projection image acquired by the camera; and when the projection region is displayed as a rectangle or a quasi rectangle, the controller acquires coordinate values of four vertices of the rectangular projection region above through a preset algorithm.

When detecting a foreign object in the projection region, the projection region may be corrected to the rectangle by using a perspective transformation method, and a difference value between the rectangle and a projection screenshot is calculated, so as to determine whether the foreign object exists in a display region; and if it is determined that there is the foreign object, the projection device will automatically trigger the eye-irradiation preventing function to be activated.

When detecting the foreign object in a certain region outside a projection range, whether the foreign object enters a region outside the projection range may be determined by subtracting camera content in a current frame from camera content in a previous frame; and the projection device automatically triggers the eye-irradiation preventing function if it is determined that the foreign object has entered.

Meanwhile, the projection device may further detect a real-time depth change in a specific region by using a time of flight (TOF) camera or a time of flight sensor; and the projection device will automatically trigger the eye-irradiation preventing function if a change of a depth value exceeds a preset threshold.

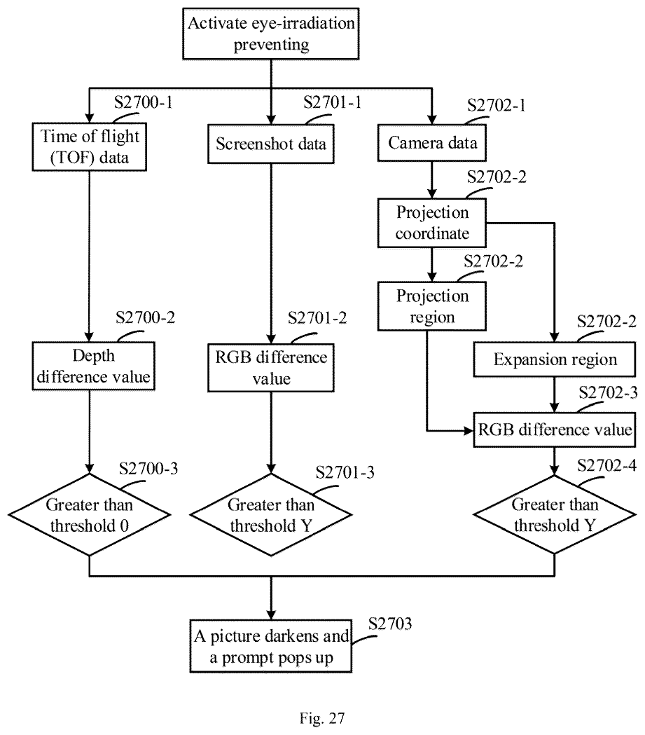

In some embodiments, as shown in FIG. 27, a flow diagram of implementing an eye-irradiation preventing algorithm by the projection device is provided. The projection device analyzes and determines whether to activate the eye-irradiation preventing function based on the collected time of flight data, screenshot data, and camera data. There are three modes for the projection device to implement the eye-irradiation preventing algorithm as follows.

### Mode 1

S2700-1, time of flight (TOF) data is collected.

S2700-2, a controller performs depth difference value analysis based on the collected time of flight data.

S2700-3, whether a depth difference value is greater than a preset threshold X is determined, and if the depth difference value is greater than the preset threshold X and X is implemented as 0, the flow goes to S2703.

If the depth difference value is greater than the preset threshold X and when the preset threshold X is implemented as 0, it may be determined that the foreign object is already in a specific region of the projection device. If the user is located in the specific region and there is a risk of laser damage to the user vision, the projection device will automatically activate the eye-irradiation preventing function, so as to reduce the intensity of the laser emitted by the light modulation assembly, lower the display brightness of the user interface, and display the safety prompt information.

### Mode 2

S2701-1, screenshot data is collected.

S2701-2, additive color mode (RGB) difference value analysis is performed according to the collected screenshot data.

S2701-3, whether a RGB difference value is greater than a preset threshold Y is determined, and if the RGB difference value is greater than the preset threshold Y, the flow goes to S2703.

S2703, the picture darkens and the prompt pops up.

The projection device performs the additive color mode (RGB) difference value analysis according to the collected screenshot data. If the additive color mode difference value is greater than the preset threshold Y, it may be determined that the foreign object is already in the specific region of the projection device. If there is a user in the specific region and there is a risk of laser damage to the user vision, the projection device will automatically activate the eye-irradiation preventing function, so as to reduce the intensity of the emitted laser, lower the display brightness of the user interface, and display the corresponding safety prompt information.

### Mode 3

S2702-1, camera data is collected.

S2702-2, projection coordinates are acquired according to the collected camera data. If the acquired projection coordinates are in the projection region, the flow goes to S2701-3. If the acquired projection coordinates are in an expansion region, the flow still goes to S2701-3.

S2702-3, the additive color mode (RGB) difference value analysis is performed according to the collected camera data.

S2702-4, whether the RGB difference value is greater than the preset threshold Y is determined, and if the RGB difference value is greater than the preset threshold Y, the flow goes to S2703.

S2703, the picture darkens and the prompt pops up.

The projection device acquires the projection coordinates according to the collected camera data, and then determines the projection region of the projection device according to the projection coordinates, and further performs the additive color mode (RGB) difference value analysis within the projection region. If the additive color mode difference value is greater than the preset threshold Y, it may be determined that the foreign object is already in the specific region of the projection device. If there is the user in the specific region and there is the risk of laser damage to the user vision, the projection device will automatically activate the eye-irradiation preventing function, so as to reduce the intensity of the emitted laser, lower the display brightness of the user interface, and display the corresponding safety prompt information.

If the acquired projection coordinates are in the expansion region, the controller may still perform the additive color mode (RGB) difference value analysis in the expansion region. If the additive color mode difference value is greater than the preset threshold Y, it may be determined that the foreign object is already in the specific region of the projection device. If there is the user in the specific region and there is the risk of damage to the user vision by the laser emitted by the projection device, the projection device will automatically activate the eye-irradiation preventing function, so as to reduce the intensity of the emitted laser, lower the display brightness of the user interface, and display the corresponding safety prompt information, as shown in FIG. 27.

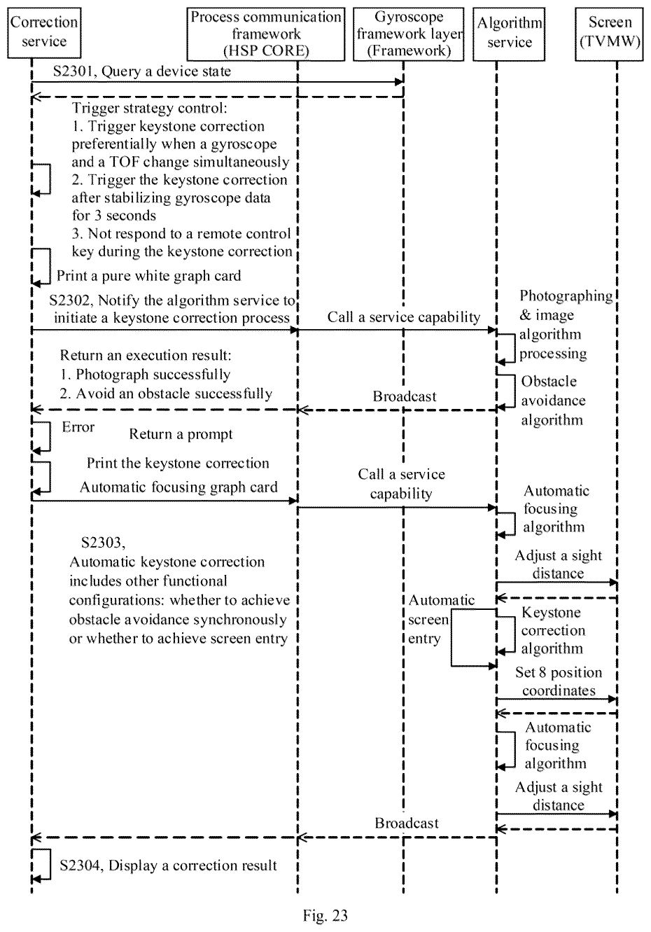

FIG. 23 shows a schematic diagram of a signaling interaction timing for achieving a display picture correction function in a projection device in another embodiment of the disclosure.

In some embodiments, the projection device can typically monitor device movement through a gyroscope or a gyroscope sensor. Step S2301, a correction service sends a signaling for querying a device status to the gyroscope and receives a signaling fed back from the gyroscope for determining whether the device has moved.

In some embodiments, a display correction strategy of the projection device may be configured that the projection device triggers keystone correction preferentially when both the gyroscope and a time of flight sensor undergo changes simultaneously; after gyroscope data is stabilized for a preset time length, step S2302, an algorithm service is notified to initiate a keystone correction process; a controller activates and triggers the keystone correction; and the controller may further configure the projection device not to respond to a command issued by a remote control key during the keystone correction. In order to cooperate with the embodiment of keystone correction, the projection device will print a pure white graph card.

The keystone correction algorithm may construct a projection surface and light modulation assembly coordinate system conversion matrix in a world coordinate system based on a binocular camera; and further calculate a homography between a projection image and a played graph card in combination with light modulation assembly internal parameters, and use this homography to achieve arbitrary shape conversion between the projection image and the played graph card.

In some embodiments, the correction service sends the signaling for notifying the algorithm service to initiate the keystone correction process to a process communication framework (HSP CORE), and the process communication framework further sends a service capability call signaling to the algorithm service to acquire the algorithm corresponding to the capability.

The algorithm service acquires and executes a photographing and picture algorithm processing service and an obstacle avoidance algorithm service, and sends them to the process communication framework in a signaling carrying manner. In some embodiments, the process communication framework executes the above algorithm and feeds back an execution result to the correction service, and the execution result may include successful photographing and successful obstacle avoidance.

In some embodiments, if an error occurs in a process of execution of the above algorithm by the projection device or a data transmission process, the correction service will control a user interface to display an error return prompt, and control the user interface to print a keystone correction and automatic focusing graph card again.

The projection device may recognize a screen through an automatic obstacle avoidance algorithm, and correct the projection image to be displayed in the screen by using a projection change, so as to realize an effect of aligning with an edge of the screen.

Through the automatic focusing algorithm, the projection device may use the time of flight (ToF) sensor to acquire a distance between a light modulation assembly and a projection surface, find an optimal image distance in a preset mapping table based on the distance, and evaluate a clarity of the projection image by using an image algorithm, so as to realize fine adjustment of the image distance based on this.

In some embodiments, step S2303, the automatic keystone correction signaling sent by the correction service to the process communication framework may include other functional configuration commands, for example, commands such as whether to implement synchronous obstacle avoidance and whether to enter the screen.

The process communication framework sends the service capability call signaling to the algorithm service, so that the algorithm service acquires and executes the automatic focusing algorithm, and adjusts a sight distance between the device and the screen. In some embodiments, after applying the automatic focusing algorithm to achieve the corresponding function, the algorithm service may further acquire and execute an automatic screen entry algorithm, and the process may include a keystone correction algorithm.

In some embodiments, the projection device executes automatic screen entry, and the algorithm service may set 8 position coordinates between the projection device and the screen; then, sight distance adjustment between the projection device and the screen is achieved through the automatic focusing algorithm again; and finally, a correction result is fed back to the correction service, and step S2304, the user interface is controlled to display the correction result, as shown in FIG. 23.

In some embodiments, the projection device may acquire a current object distance by using the automatic focusing algorithm and its configured laser ranging, so as to calculate an initial focal length and a search range; and then the projection device drives the camera to photograph and uses the corresponding algorithm for clarity evaluation.

The projection device finds the possible optimal focal length based on a search algorithm within the above search range, then repeats the above steps of photographing and evaluating the clarity, and finally finds the optimal focal length through clarity comparison, so as to complete automatic focusing.

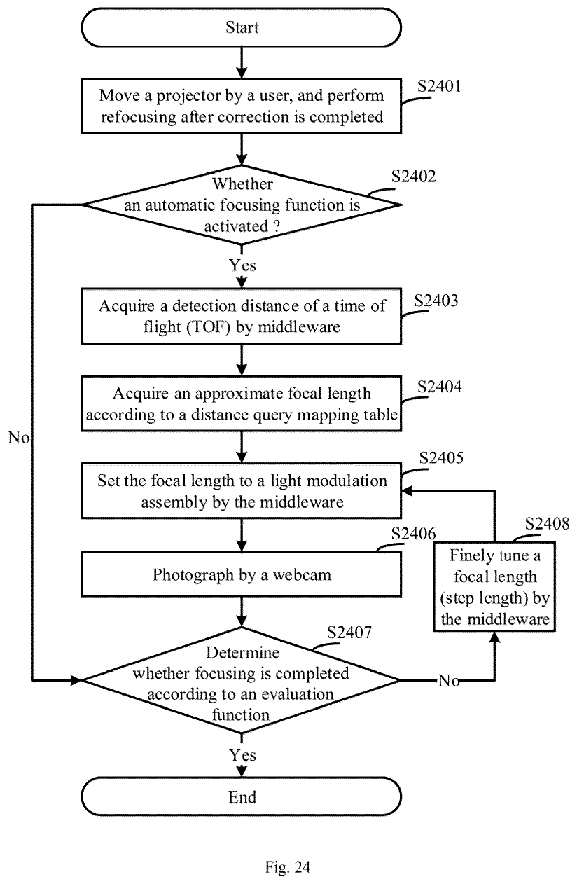

For example, after the projection device is started, the step of implementing the automatic focusing algorithm, as shown in FIG. 24, can include the following steps.

S2401, the user moves the device, and the projection device refocuses after automatically completing correction.

S2402, the controller will detect whether the automatic focusing function is activated. If not, that is, when the automatic focusing function is not activated, the controller will end an automatic focusing service. If yes, the flow goes to S2403.

S2403, middleware acquires a detection distance of time of flight (TOF); and when the automatic focusing function is activated, the projection device will calculate by acquiring the detection distance of the time of fight (TOF) sensor through the middleware.

S2404, an approximate focal length is acquired according to a distance query mapping table.

S2405, the middleware sets the focal length to the light modulation assembly; the controller queries a preset mapping table according to the acquired distance so as to acquire the approximate focal length of the projection device; and then the middleware will set the acquired focal length to the light modulation assembly of the projection device.

S2406, the webcam photographs.

S2407, whether focusing is completed is determined according to an evaluation function, if yes, the automatic focusing process ends, otherwise, the flow goes to S2408.

S2408, the middleware finely tunes the focal length (step length), and the flow goes to S2405 again.

After the light modulation assembly emits the laser at the above focal length, the webcam will execute a photo taking command; the controller determines whether the focusing of the projection device is completed according to an acquired photo taking result and the evaluation function; and if the determination result meets the preset completion condition, the automatic focusing process is controlled to end.

if the determination result does not meet the preset completion condition, the middleware will finely tune the focal length parameter of the light modulation assembly of the projection device, for example, the middleware may gradually and finely tune the focal length according to a preset step length, and set the adjusted focal length parameter to the light modulation assembly again, thereby implementing steps of repeated photographing and clarity evaluation, and finding the optimal focal length finally through clarity comparison to complete automatic focusing, as shown in FIG. 24.

In some embodiments, the projection device according to the disclosure may realize a display correction function through the keystone correction algorithm.

Firstly, based on a calibration algorithm, two groups of external parameters, namely rotation and translation matrices, between two cameras as well as between the camera and the light modulation assembly may be acquired; then, a specific chessboard graph card is played through the light modulation assembly of the projection device, and a depth value of projection chessboard corner points is calculated, for example, an xyz coordinate value is solved through a translation relationship between the binocular cameras and a similar triangle principle; and then, a projection surface is fitted based on the xyz, and its rotation relationship and translation relationship with a camera coordinate system are obtained, which may specifically include a pitch relationship and a yaw relationship.

A roll parameter value may be obtained through the gyroscope configured by the projection device, so as to combine a complete rotation matrix, and finally calculate the external parameters from the projection surface to the light modulation assembly coordinate system in the world coordinate system.

In combination with the R and T values between the camera and the light modulation assembly calculated in the above steps, the conversion relationship between the world coordinate system of the projection surface and the light modulation assembly coordinate system may be obtained; and in combination with the internal parameters of the light modulation assembly, a homography matrix from a point of the projection surface to a graph card point of the light modulation assembly may be formed.

Finally, a rectangle is selected on the projection surface, and homography is used to reversely calculate coordinates corresponding to the graph card of the light modulation assembly. The coordinates are correction coordinates, and may be set to the light modulation assembly to realize keystone correction.

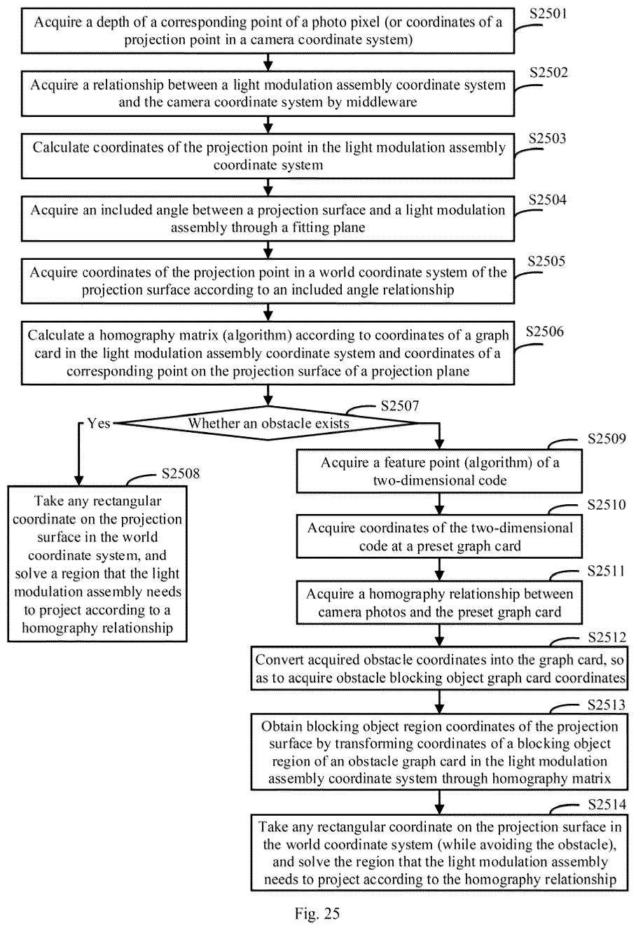

As shown in FIG. 25, a schematic flow diagram of implementing keystone correction and the obstacle avoidance algorithm by the projection device can include the following steps. S2501, the controller of the projection device acquires a depth value of a corresponding point of a photo pixel, or coordinates of a projection point in the camera coordinate system.

S2502, the middleware acquires the relationship between the light modulation assembly coordinate system and the camera coordinate system through the depth value.

S2503, then the controller calculates a coordinate value of the projection point in the light modulation assembly coordinate system.

S2504, an included angle between the projection surface and the light modulation assembly is acquired based on a coordinate value fitting plane.

S2505, the corresponding coordinates of the projection point in the world coordinate system of the projection surface are acquired according to an included angle relationship.

S2506, the homography matrix may be calculated according to the coordinates of the graph card in the light modulation assembly coordinate system and the coordinates of the corresponding point on the projection surface of the projection plane.

S2507, the controller determines whether an obstacle exists according to the acquired data, if yes, the flow goes to S2508, otherwise the flow goes to S2509.

S2508, when the obstacle exists, any rectangular coordinate is taken on the projection surface in the world coordinate system, and a region that the light modulation assembly needs to project is calculated according to the homography relationship.

S2509, when the obstacle does not exist, the controller may acquire, for example, a two-dimensional code feature point.

S2510, coordinates of a two-dimensional code on a prefabricated graph card are acquired.

S2511, the homography relationship between the camera photos and drawing graph cards is acquired.

S2512, the acquired obstacle coordinates are converted into the graph card, and obstacle blocking object graph card coordinates are acquired.

S2513, blocking object region coordinates of the projection surface are obtained through homography matrix transformation according to coordinates of a blocking object region of the obstacle graph card in the light modulation assembly coordinate system.

S2514, any rectangular coordinate is taken on the projection surface in the world coordinate system, while the obstacle is avoided, and a region that the light modulation assembly needs to project is solved according to the homography relationship.

It may be understood that in the step that the obstacle avoidance algorithm selects the rectangle in the keystone correction algorithm process, a foreign object contour is extracted by using an algorithm (OpenCV) library, and the obstacle is avoided when selecting the rectangle, so as to achieve a projection obstacle avoidance function.

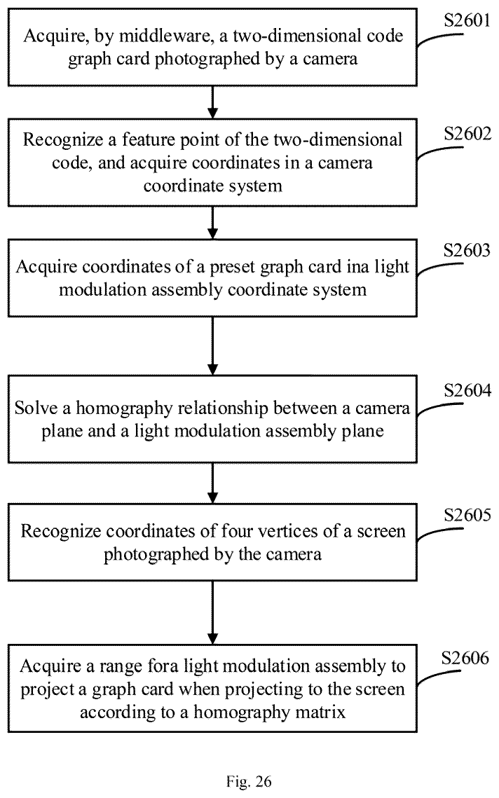

In some embodiments, as shown in FIG. 26, a schematic flow diagram of implementing a screen entry algorithm by a projection device can include the following steps.

S2601, the middleware acquires the two-dimensional code graph card photographed by the camera.

S2602, a feature point of the two-dimensional code is recognized, and coordinates in the camera coordinate system are acquired.

S2603, the controller further acquires the coordinates of the preset graph card in the light modulation assembly coordinate system.

S2604, the homography relationship between a camera plane and a light modulation assembly plane is solved.

S2605, the controller recognizes the coordinates of the four vertices of the screen photographed by the camera based on the homography relationship above.

S2606, a range for the light modulation assembly to project the graph card when projecting to the screen is acquired according to the homography matrix.

It may be understood that in some embodiments, the screen entry algorithm is based on the algorithm library (OpenCV), which can recognize a maximum black closed rectangular contour and extract it to determine whether it is a size 16:9; and project a specific graph card, take photos using a camera, extract a plurality of corner points from the photos to calculate the homography between the projection surface (screen) and the light modulation assembly playback graph card, convert the four vertices of the screen to a light modulation assembly pixel coordinate system through the homography, and convert the light modulation assembly graph card to the four vertices of the screen to complete the calculation comparison.

A long focus and micro projection television can have a characteristic of flexible movement, and the projection image may be distorted after each displacement. In addition, if there is foreign object blocking on the projection surface or the projection image is abnormal from the screen, according to the projection device and the obstacle avoidance projection detection method provided by the disclosure, correction may be automatically completed for the above problems based on a geometric correction display control method, including realization of automatic keystone correction, automatic screen entry, automatic obstacle avoidance, automatic focusing, eye-irradiation preventing and other functions.

In some embodiments, according to the projection device and the obstacle avoidance projection method according to the disclosure, the projection image is projected onto a non-foreign object region after recognizing the foreign object, so as to achieve obstacle avoidance projection.

In some embodiments, by using the automatic obstacle avoidance algorithm, the apparatus 2 for projection may perform obstacle detection, then recognize the screen, and correct the projection image to be displayed in the screen by using a projection change, so as to achieve an effect of aligning with an edge of the screen.

However, if the apparatus 2 for projection does not have the obstacle avoidance function, obstacle detection failure may occur. If the apparatus 2 for projection has the obstacle avoidance function, due to the significant impact of environmental changes during obstacle detection, for example, when there is a light spot (a bright spot and/or a dark spot) in the projection region, the projection device may mistakenly recognize the light spot as the obstacle, resulting in unstable detection result and a small projection region after obstacle detection, which does not meet the projection needs of the user and reduces the use experience of the user.

Therefore, some embodiments of the disclosure provide an apparatus 2 for projection. The apparatus 2 for projection may include a light modulation assembly 220, a camera 700, and a controller 500. The light modulation assembly 220 is used for projecting play content onto a projection region in a projection surface, and the projection surface may be a wall or a screen. The camera 700 is used for photographing an image in the projection surface. Thus a problem of obstacle detection failure or small area of the projection region after obstacle detection in the apparatus 2 for projection in a movement process of the apparatus 2 for projection used by a user is solved.

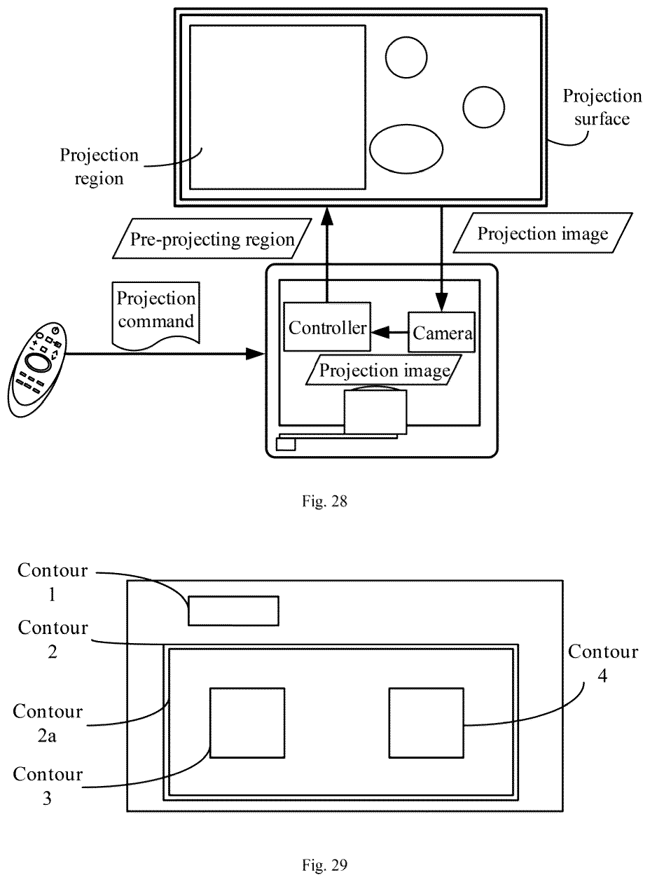

The obstacle avoidance projection process according to some embodiments of the disclosure will be further discussed below in conjunction with FIG. 28.

In some embodiments, FIG. 28 shows a schematic flow diagram of obstacle avoidance projection in a projection device according to some embodiments of the disclosure. As shown in FIG. 28, when a user inputs a projection command, a controller of the apparatus 2 for projection may, in response to a projection command, acquire a projection image, automatically detect an obstacle in the projection image, and project the projection image after determining that there is the obstacle in a projection region through an obstacle detection result, thereby achieving an automatic obstacle avoidance function. That is to say, if there is the obstacle in the projection region, the projection region of the apparatus 2 for projection before executing the obstacle avoidance process is different from the projection region for completing the obstacle avoidance process. It may be specifically set that the apparatus 2 for projection receives the projection command and activates the automatic obstacle avoidance function in response to a received projection command. The projection command can be a command used for triggering the apparatus 2 for projection to automatically perform the automatic obstacle avoidance process.

In some embodiments, the projection command may be a command actively input by a user. For example, after powering on the apparatus 2 for projection, the apparatus 2 for projection may project an image on the projection region in a projection surface. In this case, the user may press a pre-set automatic obstacle avoidance switch in the apparatus 2 for projection, or an automatic obstacle avoidance key on a remote control of the apparatus 2 for projection, so that the apparatus 2 for projection activates the automatic obstacle avoidance function to automatically detect the obstacle in the projection region.

In some embodiments, the controller, in response to the projection command, can control a light modulation assembly 220 to project a white graph card onto the projection region in the projection surface. After projecting the white graph card, a camera 700 is controlled to photograph a projection surface image. Due to the fact that an image region of the projection surface image photographed by the camera 700 is larger than an image region of the projection region, in order to acquire the image of the projection region, i.e. the projection image, the controller may calculate coordinate values of four corner points and four edge midpoints of the projection region in a light modulation assembly 220 coordinate system based on the projection image photographed by the camera 700. An included angle relationship between the projection surface and the light modulation assembly 220 is acquired based on a coordinate value fitting plane. Corresponding coordinates of the four corner points and the four edge midpoints in a world coordinate system of the projection surface are acquired according to the included angle relationship. A homography matrix may be calculated by acquiring coordinates of a white graph card in the light modulation assembly coordinate system and coordinates of the corresponding point on the projection surface. Finally, the coordinate values of the four corner points and four edge midpoints of the projection region in the light modulation assembly coordinate system are converted into corresponding coordinate values in a camera coordinate system through the homography matrix. Thus a position and a region area of the projection region in the projection surface image are determined according to the coordinate values of the four corner points and the four edge midpoints in the camera coordinate system.

In some embodiments, the controller obtains multi-contour region information by using an image contour detection algorithm based on the projection image in a process of performing obstacle contour detection on the projection image. The multi-contour region information can include an obstacle contour coordinate set. The obstacle contour coordinate set is used for representing a set including a plurality of obstacle contour coordinates. An obstacle set is acquired according to the obstacle contour coordinate set, the obstacle set includes at least one obstacle and a corresponding contour level, and the contour level is used for representing a wrapping or embedding relationship between the obstacles. It should be noted that before performing obstacle contour detection, the controller needs to remove the coordinates of four sides of the projection surface image to prevent the coordinates of the four sides of the projection surface image from affecting contour detection.

In some embodiments, the contour level corresponding to the obstacles may be represented by contour parameters. For example, the contour parameters include index numbers for the next contour, the previous contour, a child contour, and a parent contour. If there is no corresponding index number in the contour parameters of the obstacles, the index number is assigned to a negative number (represented by −1, for example).

The contour parameters are explained below exemplarily.

If a contour A includes a contour B, a contour C, and a contour D, then the contour A is the parent contour; and the contour B, the contour C, and the contour D are all child contours of the contour A. If a contour position of the contour C is at the top of the contour B, then contour C is the previous contour of the contour B. Similarly, the contour B is the next contour of the contour C.

FIG. 29 shows a schematic diagram of an obstacle set and a contour level according to some embodiments of the disclosure. Referring to FIG. 29, exemplarily, the obstacle set includes five closed contours: a contour 1, a contour 2, a contour 2a, a contour 3, and a contour 4. The contour 1 and the contour 2 are contours at an outermost layer, which belong to the same level relationship and are set as a level 0. The contour 2a is a child contour of the contour 2, that is, the contour 2a is a level, and is set as a level 1. The contour 3 and the contour 4 are the child contours of the contour 2a, that is, the contour 3 and the contour 4 are at the same level, and are set as a level 2. Therefore, contour parameters for the contour 2 are represented as [−1, 1, 2a, −1].

In some embodiments, the controller screens the obstacle set according to the contour level to obtain the obstacle set, where, the obstacle set includes at least one obstacle with the contour level being the outermost layer. That is to say, if there is a wrapping or embedding relationship between the contour relationships of the plurality of obstacles, only the obstacle corresponding to the contour at the outermost layer needs to be extracted. The objective is to avoid an obstacle corresponding to an embedded contour relative to the contour at the outermost layer as well during the achieving of the obstacle avoidance function if the obstacle corresponding to the contour at the outermost layer is avoided. Exemplarily, continuing to refer to FIG. 29, the contour with a level of 0 is screened from the five closed contours of the contour 1, the contour 2, the contour 2a, the contour 3, and the contour 4, which is the contour at the outermost layer. Furthermore, the obstacle set is generated according to the contour at the outermost layer. The obstacle set includes the contour 1 and the contour 2.

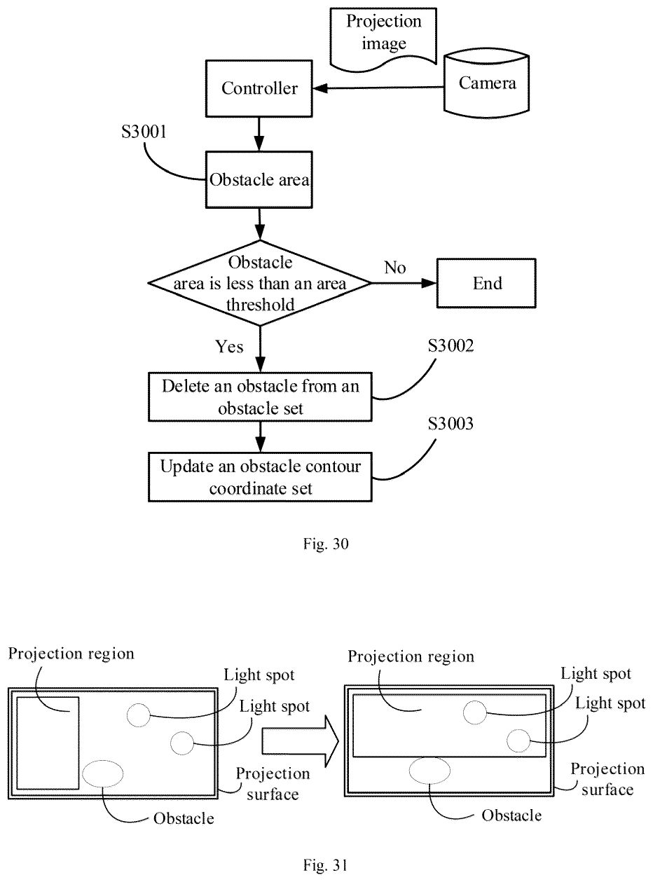

In some embodiments, referring to FIG. 30, the controller may update the obstacle set according to an image area of the projection image, so as to determine a non-obstacle region according to the updated obstacle set. Determining the non-obstacle region specifically includes S3001, when updating the obstacle set according to the image area of the projection image, the controller may acquire center coordinates, a width, and a height corresponding to each obstacle in the obstacle set; and the obstacle area corresponding to the obstacle is calculated according to the center coordinates, the width, and the height. S3002, if the obstacle area is less than a preset area threshold, the obstacle whose obstacle area is less than the preset area threshold in the obstacle set is deleted. S3003, the controller updates the obstacle contour coordinate set according to the updated obstacle set, and the updated obstacle contour coordinate set includes contour coordinates corresponding to each obstacle in the updated obstacle set.

Exemplarily, the obstacle set includes the contour 1 and the contour 2. A contour 1 region area corresponding to the contour 1 and a contour 2 region area corresponding to the contour 2 are calculated according to the center coordinates, the width, and the height corresponding to the contour 1 and the contour 2. For example, the contour 1 region area occupies 5 pixels, the contour 2 region area occupies 30 pixels, and the area threshold is 25 pixels. It can be seen that the region area corresponding to the contour 1 is smaller than the area threshold. In this case, the contour 1 in the obstacle set is deleted to complete the update of the obstacle set.

In some embodiments, when the controller performs contour detection of the obstacle on the projection image, grayscale processing may be performed on the projection image to obtain a grayscale image, edge coordinates are extracted from the grayscale image by using an edge detection algorithm, and noise removal processing is performed on the edge coordinates to obtain edge coordinates obtained after noise removal. A threshold binarization algorithm can be used to segment the image obtained after noise removal, that is, a foreground image is generated based on pixels with color values greater than a color threshold in the grayscale image, and a background image is generated based on pixels with color values less than or equal to the color threshold in the grayscale image. The color value of the pixel is a comprehensive attribute for representing features of the pixel, and the color value of the pixel is calculated based on a RGB value, a brightness, a grayscale and the like of the pixel. The image corresponding to the obstacle is distributed on the foreground image, and the background image is a background picture of the projection image. Therefore, the contour detection of the obstacle target and the light spot target may be performed according to the foreground image.

In some embodiments, the controller first performs an expansion algorithm operation on the edge coordinates in a process of controlling the execution of noise removal processing. That is, the pixel coordinates in the edge coordinates are read sequentially, and a structural element and a convolution kernel threshold are set, wherein the structural element is a 3*3 structural element, such as a convolution kernel. All the pixel coordinates and the convolution kernel are convolutionally calculated to obtain a first convolution result. If the first convolution result is greater than a convolution threshold, the pixel is set to be 1, otherwise, the pixel is set to be 0. In this way, when the convolution kernel is used to sequentially traverse the pixels in the image, if a numeric value of 1 appears in the convolution kernel, the pixel at an origin position of the corresponding convolution kernel in the edge coordinates is assigned a value of 1, otherwise, it is assigned a value of 0. Therefore, a slender image edge part may be closed through an expansion algorithm.

It should be noted that the structural element may be a structural diagram with different size ratios such as 3×3 and 5×5. The disclosure only uses a 3×3 structural diagram and assigning the pixel value of 0 or 1 as an example. The structural element may be set and the pixel values may be assigned according to specific calculation logic and algorithm parameters.

The controller may control to perform a corrosion algorithm operation on the expanded image. Specifically, the expanded pixel coordinates and the convolution kernel are convolutionally calculated to obtain a second convolution result. When the pixels in the second convolution result are all 1, the expanded pixels are made to be 1, otherwise, the expanded pixels are made to be 0. Furthermore, noise stains in the expanded pixel coordinates are removed. At the same time, it is possible to smooth a boundary of a larger object without obviously changing the area of the larger object.

In some embodiments, referring to FIG. 31, due to the influence of ambient light, a light spot may be formed in the projection surface. In the process of performing contour detection of the obstacle in the projection image, the controller may mistakenly detect the light spot as the obstacle. Therefore, the generated obstacle set not only includes the obstacle located between the light modulation assembly and the projection and capable of obstructing the projection surface, but also includes the light spot in the projection surface, and the corresponding obstacle contour coordinate set not only includes the obstacle contour coordinates, but also includes a light spot contour coordinate set, resulting in a problem that the projection region area is too small. Therefore, in order to avoid the influence of the light spot in the projection surface on obstacle contour detection, a contact ratio of a light spot target relative to an obstacle target may be acquired according to the obstacle contour coordinate set and the light spot contour coordinate set; and the obstacle contour coordinates corresponding to the obstacle target in the obstacle contour coordinate set are deleted based on the contact ratio being greater than a preset contact ratio threshold, so as to determine the projection region according to the updated obstacle contour coordinates.

In some embodiments, the light spot includes a bright spot. The bright spot is formed by the refraction of light in the projection surface and is presented as a luminous style. The light spot contour coordinate set includes bright spot contour coordinates. Since the brightness of the bright spot is usually greater than a certain numeric value, the controller may recognize the bright spot based on the color value of each pixel in the foreground image.

When performing the contour detection of the light spot target on the projection image, the controller may acquire the foreground image converted into the grayscale image, traverse the color value of each pixel in the foreground image, compare the color value of each pixel with a preset brightness threshold, acquire the bright spot image based on the pixels whose color values are greater than the preset brightness threshold in the foreground image, perform noise removing processing on the bright spot image to obtain the light spot image obtained after noise removal, and detect the light spot image obtained after noise removal by using the contour detection algorithm, so that the bright spot contour coordinates in the bright spot image with the highest contour level may be obtained.

The process that the controller performs the noise removal processing on the bright spot image may refer to the aforementioned process that the controller performs the noise removal processing on the contour coordinates of the obstacle when performing contour detection of the obstacle, and the process that the controller perform contour detection corresponding to the highest level of contour on the bright spot image may refer to the aforementioned process of performing contour detection corresponding to the highest level of contour on the obstacle, which will not be repeated here.

In some embodiments, the light spot further includes a dark spot. The dark spot is formed by light being obstructed in the projection surface and presented in a shadow style. The light spot contour coordinate set includes dark spot contour coordinates. The controller may perform contour detection of the light spot target on the projection image so as to acquire the dark spot contour coordinates corresponding to the dark spot in the projection image.

When performing contour detection of the light spot target on the projection image, the controller may acquire a hue, saturation and value (HSV) projection image converted from the projection image to the HSV color space. Each pixel in the HSV projection image corresponds to a brightness parameter V, a hue parameter H, and a saturation parameter S. The controller may use an Ostu algorithm (a maximum between-class variance algorithm) or an iterative method to calculate a shadow threshold of the HSV projection image based on the brightness parameter V, the hue parameter H, and the saturation parameter S of each pixel in the HSV projection image, and use a difference value algorithm to calculate a difference value component M of each pixel according to the brightness parameter, the hue parameter H, and the saturation parameter of the pixel in the projection image, where M=(S−V)/(S+V+H).

The controller traverses each pixel to obtain a pixel with the difference value component M being greater than the shadow threshold. By using a morphological closing operating and the pixel with the difference value component M being greater than the shadow threshold, a dark spot image may be obtained. The noise removal processing is performed on the dark spot image to obtain the dark spot image obtained after noise removal. The dark spot image obtained after noise removal is detected by using a contour detection algorithm, so that the dark spot contour coordinates in the dark spot image with the highest contour level may be obtained.

The process that the controller performs the noise removal processing on the dark spot image may refer to the aforementioned process that the controller performs the noise removal processing on the contour coordinates of the obstacle when performing contour detection of the obstacle, and the process that the controller perform contour detection corresponding to the highest level of contour on the dark spot image may refer to the aforementioned process of performing contour detection corresponding to the highest level of contour on the obstacle, which will not be repeated here.

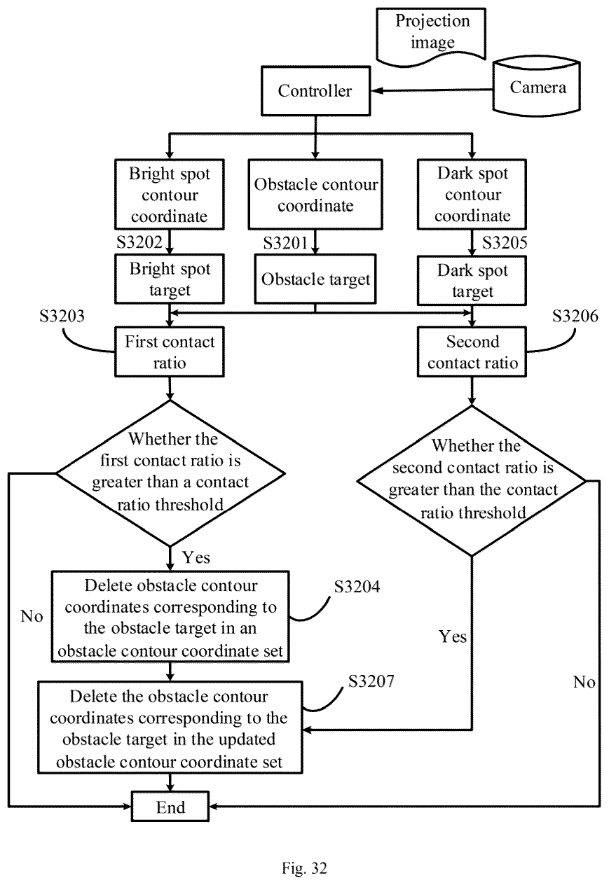

In some embodiments, referring to FIG. 32, FIG. 32 is a schematic flow diagram of updating the obstacle contour coordinate set according to some embodiments of the disclosure. After acquiring the bright spot contour coordinates and the dark spot contour coordinates, the controller may retrieve the obstacle contour coordinate set and perform the following steps.

S3201, the obstacle target is acquired according to the obstacle contour coordinate set.

S3202, a bright spot target is acquired according to the bright spot contour coordinate set.

S3203, a first contact ratio of the bright spot target relative to the obstacle target is calculated.

S3204, if the first contact ratio is greater than a preset contact ratio threshold, obstacle contour coordinates corresponding to the obstacle target having the first contact ratio with the bright spot target being greater than the preset contact ratio threshold are deleted from the obstacle contour coordinate set.

S3205, a dark spot target is acquired according to the dark spot contour coordinate set.

S3206, a second contact ratio of the dark spot target relative to the obstacle target is acquired.

S3207, if the second contact ratio is greater than the preset contact ratio threshold, obstacle contour coordinates corresponding to the obstacle target having the second contact ratio with the dark spot target being greater than the preset contact ratio threshold are deleted from the obstacle contour coordinate set, so as to complete the update of the obstacle contour coordinate set.

In some embodiments, the controller may determine a non-obstacle region in the projection image based on the updated obstacle contour coordinate set. The non-obstacle region refers to a region, other than the region corresponding to the obstacle, in the projection image. In some embodiments, the controller can acquire the obstacle contour coordinates corresponding to each obstacle in the obstacle contour coordinate set, and an image coordinate set corresponding to the projection image. The obstacle contour coordinates are removed from the image coordinate set so as to determine the non-obstacle region according to the image coordinate set after the obstacle contour coordinates are removed. Typically, the non-obstacle region is a polygonal region.

In some embodiments, the controller may extract a pre-projecting region in the non-obstacle region. The pre-projecting region is a rectangular region in the non-obstacle region. The controller can determine the projection region in the projection surface according to the extracted pre-projecting region and a photographing parameter of the camera, and can control the light modulation assembly to project the play content to the projection region.

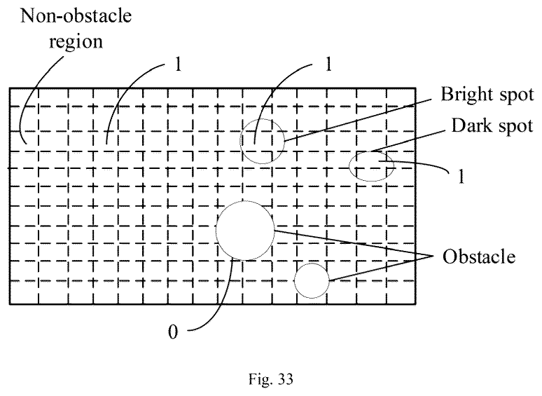

FIG. 33 shows a schematic diagram of a rectangular grid and a non-obstacle region according to some embodiments of the disclosure. Referring to FIG. 33, the controller may acquire corner point coordinates of the projection image, wherein the corner point coordinates are coordinates corresponding to four vertices and/or four side midpoints of the projection image. The rectangular grid is constructed based on the corner point coordinates, and includes MxN grids. Next, all grids are traversed to determine an inclusion relationship between each grid and the non-obstacle region. If the grid is located in the non-obstacle region, a grid identifier of the grid is assigned a value of 1. If the grid is not located in the non-obstacle region, the grid identifier of the grid is assigned a value of 0.

The controller may find the rectangular region comprising the grid with the grid identifier being 1 in the rectangular grid, and determine the rectangular region as the pre-projecting region. Furthermore, the pre-projecting region in the projection image is converted to the projection region in the projection surface according to a photographing parameter of the camera 700, and the light modulation assembly 220 is controlled to project the play content into the projection region, realizing the automatic obstacle avoidance function.

In order to enable the user to watch more play content and improve the use experience of the user, the controller should find the largest rectangular region comprising the grid with the grid identifier being 1 in a process of finding the rectangular region comprising the grid with the grid identifier being 1 in the rectangular grid, that is, acquire the largest rectangular region in the non-obstacle region. In some embodiments, all the rectangular regions composed of the grid with the grid identifier being 1 are traversed to obtain the number of pixels in each rectangular region. The rectangular region with the highest number of pixels is extracted, and a pre-projecting region is determined based on boundary coordinates of a rectangular region with the maximum number of pixels.

In some embodiments, in order to avoid the influence of the viewing experience of the user due to the too small area of the pre-projecting region, the controller may set an area threshold by calculating a ratio of the region area of the rectangular region to an image arca of the projection image after acquiring the rectangular region in the non-obstacle region. If the area ratio is greater than the area threshold, it indicates that the region area of the rectangular region meets a region area condition, and the rectangular region is determined as the pre-projecting region.

It should be noted that in order to ensure whether the non-obstacle region conforms to a user actual environment and a user visual mechanism, when determining the pre-projecting region, if the maximum number of rectangular region found is multiple, the controller extracts a rectangular region with a center point of a projection graph as an extended baseline from the plurality of maximum rectangular regions, so as to calculate the area ratio according to the extracted rectangular region.

In some embodiments, if the area ratio is less than the area threshold, that is, the region area of the largest rectangular region in the non-obstacle region is small compared to the image area of the projection image, the controller can perform the process of updating the non-obstacle region, and extracts the pre-projecting region in the updated non-obstacle region again to determine the projection region in the projection surface according to the pre-projecting region.

In some embodiments, in order to improve imaging quality of the projection image, the controller may optimize the picture quality of the projection image by adjusting the brightness of the projection image, making the brightness distribution of the adjusted projection image more uniform.

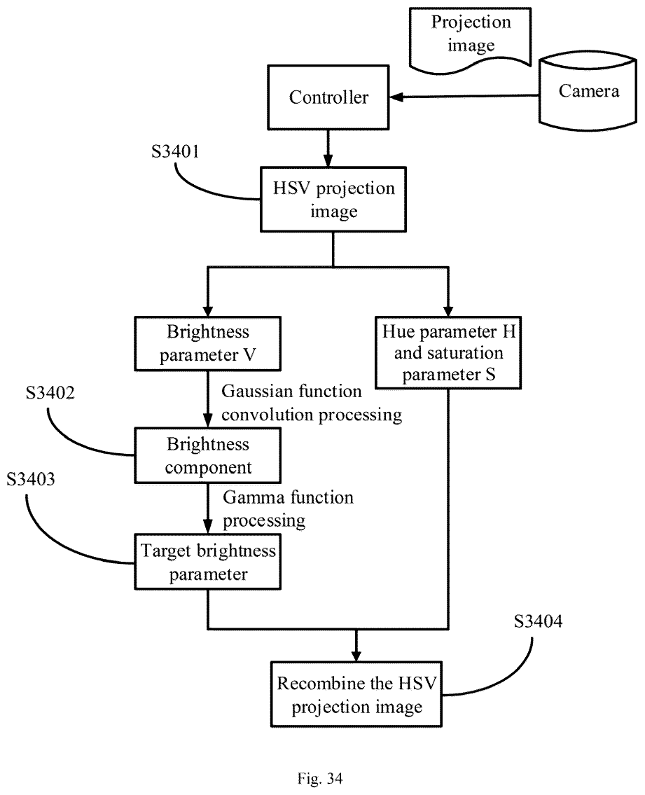

In some embodiments, referring to FIG. 34, the controller may perform the following steps to adjust the projection image.

S3401, the controller may acquire the HSV projection image converted from the projection image to the HSV color space, wherein each pixel in the HSV projection image corresponds to the brightness parameter V, the hue parameter H, and the saturation parameter S.

S3402, the controller may perform Gaussian function convolution processing on the brightness parameter of each pixel in the HSV projection image to obtain a brightness component corresponding to each pixel.

S3403, the controller may perform gamma function processing on the brightness component to obtain a target brightness parameter.

S3404, the controller recombines the HSV projection image based on the target brightness parameter, the hue parameter H, and the saturation parameter S to adjust the brightness of the HSV projection image.

In some embodiments, the controller may acquire a grayscale image converted from the projection image to the grayscale space, and calculate an average brightness value of the grayscale image based on a brightness value of each pixel in the grayscale image. And, the controller may control to divide the grayscale image into a preset quantity of image regions, and calculate the average brightness value of each image region based on the brightness value of each pixel in the image region. The controller adjusts the brightness value of each pixel in the image region based on the difference value between the average brightness value of the grayscale image and the average brightness value of the image region. An adjustment amplitude of the brightness value of each pixel in the image region may be the same or different, so that the average value corresponding to the brightness values of the pixels in each adjusted image region is equal to the average brightness value of the grayscale image.

The above method of optimizing the brightness of the projection image by the controller is only discussed for illustration in the disclosure. The disclosure does not intend to limit the method of adjusting the brightness of the projection image. In other embodiments, the controller may further directly perform optimization processing on the projection image by using an adaptive local histogram equalization algorithm, making the brightness distribution of the optimized projection image more uniform and improving the picture quality.

In some embodiments, the disclosure can provide an obstacle avoidance projection method for a projection device, the projection device includes a light modulation assembly, a camera and a controller, and the obstacle avoidance projection method can include: in response to a projection command from a user, acquiring a projection image in a projection surface photographed by the camera; performing contour detection of an obstacle target and a light spot target on the projection image based on a color parameter to obtain an obstacle contour coordinate set and a light spot contour coordinate set, the color parameter including a brightness parameter, a hue parameter, and a saturation parameter; acquiring a contact ratio of the light spot target relative to the obstacle target according to the obstacle contour coordinate set and the light spot contour coordinate set; deleting, if the contact ratio is greater than a preset contact ratio threshold, obstacle contour coordinates corresponding to the obstacle target in the obstacle contour coordinate set; and determining a non-obstacle region based on the obstacle contour coordinate set after deletion, and controlling the light modulation assembly to project play content to a projection region according to the non-obstacle region.

In some embodiments, before performing contour detection of the obstacle target and the light spot target on the projection image based on the color parameter, grayscale processing may be performed on the projection image to obtain a grayscale image; edge coordinates are extracted from the grayscale image by using an edge detection algorithm; noise removal processing is performed on the edge coordinates to obtain edge coordinates obtained after noise removal; a color threshold is calculated based on color values of pixels at positions of edge coordinates; and a foreground image is generated based on pixels with color values greater than the color threshold in the grayscale image, so as to perform contour detection of the obstacle target and the light spot target according to the foreground image.

In some embodiments, before extracting the edge coordinates from the grayscale image by using the edge detection algorithm, an average brightness value of the grayscale image may be calculated based on brightness values of the pixels in the grayscale image; the grayscale image is divided into a preset quantity of image regions, and the average brightness value of the image region is calculated based on the brightness value of each pixel in the image region; and the brightness value of each pixel in the image region is adjusted based on a difference value between the average brightness value of the grayscale image and the average brightness value of the image region.

In some embodiments, obtaining the grayscale image includes: converting the projection image to a HSV color space to obtain a HSV projection image; performing Gaussian function convolution processing on a brightness parameter of the HSV projection image to obtain a brightness component; performing gamma function processing on the brightness component to obtain a target brightness parameter; adjusting a brightness of the HSV projection image based on the target brightness parameter; and performing grayscale processing on the adjusted HSV projection image to obtain the grayscale image.

In some embodiments, obtaining the obstacle contour coordinate set can include: acquiring an obstacle set according to the obstacle contour coordinate set, wherein the obstacle set includes at least one obstacle with a contour level being an outermost layer, and the contour level is used for representing a wrapping or embedding relationship between the obstacles; acquiring center coordinates, a width, and a height of the obstacle in the obstacle set; calculating an obstacle area corresponding to the obstacle according to the center coordinates, the width, and the height; deleting the obstacle in the obstacle set if the obstacle area is less than a preset arca threshold; and updating the obstacle contour coordinate set according to the updated obstacle set.

In some embodiments, the light spot target includes a bright spot, the light spot contour coordinate set includes bright spot contour coordinates, and performing contour detection of the obstacle target and the light spot target on the projection image based on the color parameter includes: acquiring a bright spot image based on pixels with color values greater than a preset brightness threshold in the foreground image; performing noise removal processing on the bright spot image to obtain a bright spot image obtained after noise removal; and detecting the bright spot image obtained after noise removal by using a contour detection algorithm so as to obtain the bright spot contour coordinates in the bright spot image.

In some embodiments, the light spot target includes a dark spot, the light spot contour coordinate set includes dark spot contour coordinates, and performing contour detection of the obstacle target and the light spot target on the projection image based on the color parameter includes: converting the projection image to a HSV color space to obtain the HSV projection image; calculating a shadow threshold of the HSV projection image by using a maximum between-class variance algorithm according to the brightness parameters, the hue parameters, and the saturation parameters of the pixels in the HSV projection image; calculating a difference value components of the pixels by using a difference value algorithm according to the brightness parameters, the hue parameters, and the saturation parameters of the pixels in the HSV projection image; acquiring a dark spot image based on pixels in the HSV projection image with the difference value component greater than the shadow threshold; and detecting the dark spot image by using a contour detection algorithm so as to obtain the dark spot contour coordinates in the dark spot image.

In some embodiments, deleting the obstacle contour coordinates corresponding to the obstacle target in the obstacle contour coordinate set further can include: if it is detected that a contact ratio of the bright spot target relative to the obstacle target is greater than the preset contact ratio threshold, deleting obstacle contour coordinates corresponding to the obstacle target having the contact ratio with the bright spot target being greater than the preset contact ratio threshold from the obstacle contour coordinate set; and if it is detected that a contact ratio of the dark spot target relative to the obstacle target is greater than the preset contact ratio threshold, deleting obstacle contour coordinates corresponding to the obstacle target having the contact ratio with the dark spot target being greater than the preset contact ratio threshold from the obstacle contour coordinate set.

In some embodiments, controlling the light modulation assembly to project the play content to the projection region according to the non-obstacle region can include: acquiring a rectangular region in the non-obstacle region and the number of pixels in the rectangular region; determining a pre-projecting region based on boundary coordinates of a rectangular region with the maximum number of pixels; and calculating the projection region in the projection surface according to the pre-projecting region and a photographing parameter of the camera, and controlling the light modulation assembly to project the play content to the projection region.

What is claimed is:

1. A projection device, comprising:
a lens;
a light modulation assembly, configured to project projection content onto a projection surface;
a distance sensor, configured to detect a distance value between the projection surface and the light modulation assembly;
an image collection device, configured to capture a projection image corresponding to the projection content; and
a controller, in connection with the lens, the light modulation assembly, the distance sensor, and the image collection device and configured to execute instructions to cause the projection device to:
in response to a power-on command for the projection device, start the projection device;
detect whether a blocking object exists between the projection device and the projection surface according to a positional relationship of the lens, the distance sensor and the image collection device on a first plane and the distance value of the distance sensor, wherein the first plane is a plane on the projection device that is parallel to the projection surface during projection; and
based on that it is detected that the blocking object exists between the projection device and the projection surface, control sending of prompt information for prompting to remove the blocking object.

2. The projection device according to claim 1, wherein the image collection device comprises a first camera and a second camera, the first camera and the lens are arranged at a first position on the first plane, and the second camera and the distance sensor are arranged at a second position different from the first position on the first plane; and the controller is further configured to execute instructions to cause the projection device to:
based on that the distance detection value is not greater than a distance threshold, determine that the blocking object exists between the projection device and the projection surface, wherein the distance threshold is set based on a safe distance between the lens and the blocking object;
based on that the distance detection value is greater than the distance threshold, control the first camera to collect a first image and controlling the second camera to collect a second image; and
detect whether the blocking object exists between the projection device and the projection surface according to a similarity between the first image and the second image.

3. The projection device according to claim 2, wherein the controller is further configured to execute instructions to cause the projection device to:
calculate the similarity between the first image and the second image;
based on that the similarity is less than a similarity threshold, determine that the blocking object exists between the projection device and the projection surface; and
based on that the similarity is not less than the similarity threshold, determine that no blocking object exists between the projection device and the projection surface.

4. The projection device according to claim 1, wherein the lens, the distance sensor, and the image collection device are arranged on the same side on the first plane, and the controller is further configured to execute instructions to cause the projection device to:
based on that the distance value is less than a spacing distance between the projection surface and the light modulation assembly, determine that the blocking object exists between the projection device and the projection surface; and
based on that the distance detection value is equal to the spacing distance between the projection surface and the light modulation assembly, determine that no blocking object exists between the projection device and the projection surface.

5. The projection device according to claim 1, wherein the controller is further configured to execute instructions to cause the projection device to:
based on that it is detected that the blocking object exists between the projection device and the projection surface, control the light modulation assembly to stop projecting the projection content onto the projection surface.

6. The projection device according to claim 5, wherein the controller is further configured to execute instructions to cause the projection device to:
after controlling the light modulation assembly to stop projecting the projection content onto the projection surface, re-detect whether the blocking object exists between the projection device and the projection surface at preset intervals; and
based on that it is detected that no blocking object exists between the projection device and the projection surface, control the light modulation assembly to project the projection content onto the projection surface.

7. The projection device according to claim 1, wherein the controller is further configured to execute instructions to cause the projection device to:
recognize a projection region of the projection device by using an edge detection algorithm based on the projection image acquired by the image collection device;
based on that the projection region is displayed as a rectangle or a quasi rectangle, acquire coordinate values of four vertices of the rectangular projection region through a preset algorithm.

8. The projection device according to claim 7, wherein the controller is further configured to execute instructions to cause the projection device to:
correct the projection region to the rectangle by using a perspective transformation method, and determine a difference value between the rectangle and a projection screenshot, so as to determine whether a foreign object exists in a display region.

9. The projection device according to claim 7, wherein the controller is further configured to execute instructions to cause the projection device to:
based on that detecting the foreign object in a certain region outside a projection range, determine whether the foreign object enters a region outside the projection range by subtracting content in a current frame of the image collection device from content in a previous frame of the image collection device; and
based on that it is determined that the foreign object has entered, automatically trigger an eye-irradiation preventing function.

10. The projection device according to claim 7, wherein the controller is further configured to execute instructions to cause the projection device to:
detect a real-time depth change in a specific region by using a time of flight camera or a time of flight sensor; and in response to a change of a depth value exceeding a preset threshold, control that the projection device automatically triggers an eye-irradiation preventing function.

11. The projection device according to claim 7, wherein the controller is further configured to execute instructions to cause the projection device to:
analyze and determine whether an eye-irradiation preventing function needs to be activated based on collected time of flight data, screenshot data, and data of the image collection device.

12. The projection device according to claim 7, wherein the controller is further configured to execute instructions to cause the projection device to:
based on that it is detected that a specific object is located within a predetermined region, automatically activate an eye-irradiation preventing function, so as to reduce intensity of laser emitted from the light modulation assembly, lower a display brightness of a user interface, and display safety prompt information.

13. A method for a projection device, comprising:
in response to a power-on command for a projection device, starting the projection device;
detecting whether a blocking object exists between the projection device and a projection surface according to a positional relationship of a lens, a distance sensor and an image collection device on a first plane and a distance value of the distance sensor, wherein the first plane is a plane on the projection device that is parallel to the projection surface during projection; and
based on that it is detected that the blocking object exists between the projection device and the projection surface, controlling sending of prompt information for prompting to remove the blocking object.

14. The method according to claim 13, wherein the image collection device comprises a first camera and a second camera, the first camera and the lens are arranged at a first position on the first plane, and the second camera and the distance sensor are arranged at a second position different from the first position on the first plane; and the method further comprising:
based on that the distance detection value is not greater than a distance threshold, determining that the blocking object exists between the projection device and the projection surface, wherein the distance threshold is set based on a safe distance between the lens and the blocking object;
based on that the distance detection value is greater than the distance threshold, controlling the first camera to collect a first image and controlling the second camera to collect a second image; and
detecting whether the blocking object exists between the projection device and the projection surface according to a similarity between the first image and the second image.

15. The method according to claim 14, further comprising:
calculating the similarity between the first image and the second image;
based on that the similarity is less than a similarity threshold, determining that the blocking object exists between the projection device and the projection surface; and
based on that the similarity is not less than the similarity threshold, determining that no blocking object exists between the projection device and the projection surface.

16. The method according to claim 13, wherein the lens, the distance sensor, and the image collection device are arranged on the same side on the first plane, and the method comprises:
based on that the distance value is less than a spacing distance between the projection surface and the light modulation assembly, determining that the blocking object exists between the projection device and the projection surface; and
based on that the distance detection value is equal to the spacing distance between the projection surface and the light modulation assembly, determining that no blocking object exists between the projection device and the projection surface.

17. The method according to claim 13, further comprising:
based on that it is detected that the blocking object exists between the projection device and the projection surface, controlling the light modulation assembly to stop projecting the projection content onto the projection surface.

18. The method according to claim 17, further comprising:
after controlling the light modulation assembly to stop projecting the projection content onto the projection surface, re-detecting whether the blocking object exists between the projection device and the projection surface at preset intervals; and
based on that it is detected that no blocking object exists between the projection device and the projection surface, controlling the light modulation assembly to project the projection content onto the projection surface.

19. The method according to claim 13, further comprising:
recognizing a projection region of the projection device by using an edge detection algorithm based on the projection image acquired by the image collection device;
based on that the projection region is displayed as a rectangle or a quasi rectangle, acquiring coordinate values of four vertices of the rectangular projection region through a preset algorithm.

20. The method according to claim 19, further comprising:
correcting the projection region to the rectangle by using a perspective transformation method, and determine a difference value between the rectangle and a projection screenshot, so as to determine whether a foreign object exists in a display region.
